(19) United States
(12) Patent Application Publication
(10) Pub. No.: US 2026/0116280 A1
(43) Pub. Date: Apr. 30, 2026

(54) VEHICLE ACCESS MOBILITY TOOL

(71) Applicant: Meera RAMASWAMI, Ann Arbor, MI (US)

(72) Inventor: Meera RAMASWAMI, Ann Arbor, MI (US)

(21) Appl. No.: 19/402,297

(22) Filed: Nov. 26, 2025

Related U.S. Application Data
(63) Continuation-in-part of application No. 18/302,222, filed on Apr. 18, 2023, now Pat. No. 12,491,810.
(60) Provisional application No. 63/344,529, filed on May 20, 2022.

(51) Int. Cl. B60N 3/02; F16B 7/10

(52) U.S. Cl. CPC B60N 3/026; F16B 7/105

(57) ABSTRACT

A vehicle access device for helping a person to enter and exit a vehicle is provided. The vehicle access device includes an engagement portion configured to engage a striker in a doorframe of a vehicle and to hold the device in a fixed relationship relative to the striker. The device further includes an articulating leg coupled to the engagement portion, the articulating leg including a first member pivotably connected to a second member.

### CROSS-REFERENCE TO RELATED APPLICATIONS

This application is a continuation-in-part of U.S. patent application Ser. No. 18/302,222, filed Apr. 18, 2023, entitled “Vehicle Access Mobility Tool,” which claims priority to and the benefit of U.S. Provisional Ser. No. 63/344,529 , filed on May, 20, 2022, entitled “Vehicle Access Mobility Tool,” the disclosures of which are hereby incorporated by reference in their entirety.

### TECHNICAL FIELD

The present disclosure generally relates to mobility assisting devices and, more particularly, to systems, devices, and methods for assisting movements of an individual getting in and out of a compartment of a vehicle.

### BACKGROUND

Various mobility aids, such as canes and walkers, wheelchairs, or person lifts, provide a walking support and can assist people in getting in and out of bed, transitioning to or from a sitting position, and accessing vehicles. Such tools can greatly benefit older people or people with arthritis, leg or foot injuries, balance problems, strokes, and degenerative diseases such as multiple sclerosis by providing adequate balance and support. Some of these mobility aids may be expensive, space inefficient, or difficult to set up. Among mobility assisting devices, canes may be relatively inexpensive and require less space than some other, more complex mobility assisting devices.

While standard canes can provide some walking support, these canes do not provide sufficient support to a user when getting into and out of a vehicle or other types of compartments. Thus, there is a need for mobility assisting devices that can help with such a task.

### SUMMARY

A vehicle access device for assisting a person in entering and exiting a vehicle is provided. Consistent with a disclosed embodiment, the device includes an engagement portion configured to engage a striker in a doorframe of a vehicle and to hold the device in a fixed relationship relative to the striker. The device further includes an articulating leg coupled to the engagement portion, the articulating leg including a first member pivotably connected to a second member.

Consistent with another disclosed embodiment, a kit for assembling a vehicle access device is provided. The kit includes an engagement portion configured to engage a striker in a doorframe of a vehicle and to hold the device in a fixed relationship relative to the striker, a first member of an articulating leg having a first end and a second end, the first end configured to be coupled to the engagement portion, a second member of the articulating leg having a first end and a second end, a central joint configured to pivotably connect the first member and the second member by coupling to a second end of the first member and to the first end of the second member, and a base configured to couple to the second end of the second member.

Consistent with another disclosed embodiment, a method for engaging a vehicle access device with a vehicle is provided. The method includes engaging an engagement portion of a vehicle access device to a striker located in a doorframe of a vehicle by placing a top surface of the engagement portion under and adjacent to a back portion of the striker element, and by placing a bottom surface of the engagement portion over and adjacent to the front portion of the striker element. Further the method includes unfolding an articulating leg coupled to the engagement portion by forming a selected angle between a first member and a second member of the articulating leg such that the selected angle is larger than 90 degrees, the first member being pivotably connected to the second member and locking the first member in a fixed position relative to the second member.

Consistent with another disclosed embodiment, a method for disengaging a vehicle access device is provided. The method includes disengaging an engagement portion of the vehicle access device from a striker in a doorframe of a vehicle, the engagement portion when engaged with the striker configured to hold the vehicle access device in a fixed relationship relative to the striker and unlocking a first member of an articulating leg from being in a fixed position relative to a second member of the articulating leg, the first member being pivotably connected to the second member. The method further includes folding the articulating leg by pivoting the first member relative to the second member such that the first member is substantially parallel to the second member.

Provided herein is a device including an engagement portion and an articulating leg assembly. The engagement portion includes a rigid member configured to engage with a striker located in a doorframe of a vehicle and to hold the device in a fixed relationship relative to the striker. The articulating leg is coupled to the rigid member and includes a first member and a second member pivotably connected by a central joint. The second member includes a right second member and a left second member, and an extension mechanism operably coupled to the central joint and to the right and left second members. The extension mechanism is configured to adjust a length of the second member relative to a ground surface.

In some embodiments, the extension mechanism includes an elongated portion having a plurality of apertures disposed longitudinally along its length, and a connector body including first and second portions coupled together to define an inner cavity. The inner cavity is configured to receive the elongated portion along with the right and left second members, with the elongated portion positioned between the right and left second members.

In some embodiments, the connector body includes a first end and a second end, where the first end includes a protruding shoulder configured to engage the right second member, and the second end includes a protruding shoulder configured to engage the left second member.

In some embodiments, the device includes a release pin mechanism disposed within the inner cavity and operably coupled to the elongated portion, and a button accessible through an external surface of the connector body. The button is configured to actuate the release pin mechanism, thereby selectively locking or releasing the elongated portion.

In some embodiments, a locking mechanism is configured to engage one of the apertures along the elongated portion to secure it at a desired position. The elongated portion may include a tubular member having a non-circular cross-section.

In some embodiments, the central joint includes a hinge mechanism having a biasing assembly disposed within an internal cavity formed between coupled hinge members. The biasing assembly includes a movable member and an elastic element configured to urge the movable member toward one or more detent recesses corresponding to discrete angular positions, maintaining the articulating leg in each position until a threshold torque is applied to transition between positions.

In some embodiments, the biasing assembly includes a ball-and-spring arrangement configured to urge a ball into detent recesses corresponding to open and closed positions, the spring maintaining the articulating leg in either position until a sufficient force is applied to transition between them. The internal cavity may include an arcuate track having detent recesses corresponding to angular positions between about 0 degrees in a closed position and about 120 degrees in an open position, with movement of the ball along the track dictating transition between positions.

In some embodiments, the hinge members include a dowel pin received within a guide slot defining an arcuate path with detent recesses corresponding to open and closed positions, the dowel pin configured to snap into the detent recesses to maintain the articulating leg in position until a sufficient force is applied to move between positions.

In some embodiments, a grip material is disposed on at least a portion of a surface of the second member. In some embodiments, a proximal portion of the rigid member includes a flared segment protruding outward from the rigid member, the flared segment having an indented region configured to interface with a D-ring striker plate. In some embodiments, a distal end of the right second member is coupled to a first base, and a distal end of the left second member is coupled to a second base.

Provided herein is also a method including engaging an engagement portion of the device with a striker located in a vehicle doorframe, unfolding an articulating leg coupled to the engagement portion, forming a selected angle between the first and second members of the articulating leg greater than ninety degrees, and placing the right and left second members on a ground surface to support the device. In some embodiments, engaging the engagement portion includes inserting a proximal flared segment of the rigid member beneath the striker such that an indented region of the flared segment receives and supports a lower portion of the striker.

In some embodiments, the method includes locking the first member in a fixed position relative to the second member and adjusting the length of the second member relative to the ground surface by actuating the extension mechanism. In certain embodiments, adjusting the length includes sliding the elongated portion having a plurality of apertures longitudinally along its length within the connector body and locking it at a selected position using a locking mechanism or release pin mechanism actuated by a button accessible through an external surface of the connector body.

Provided herein is also a kit including the engagement portion and the articulating leg described above, where the right and left second members are each configured to be placed on a ground surface through respective bases coupled to their distal ends. In some embodiments, the kit includes an elongated portion configured to be received within a connector body defining an inner cavity that slidably connects the elongated portion to the right and left second members to allow adjustment of the length of the second member.

The foregoing general description and the following detailed description are exemplary and explanatory only and are not restrictive of the claims.

### BRIEF DESCRIPTION OF THE DRAWINGS

The skilled artisan will understand that the drawings primarily are for illustrative purposes and are not intended to limit the scope of the inventive subject matter described herein. The drawings are not necessarily to scale; in some instances, various aspects of the inventive subject matter disclosed herein may be shown exaggerated or enlarged in the drawings to facilitate an understanding of different features. In the drawings, like reference characters generally refer to like features (e.g., functionally similar and/or structurally similar elements).

FIG. 1A is an example diagram of a vehicle access device, according to an embodiment.

FIG. 1B is an example striker fixedly mounted to an interior of a vehicle door frame, according to an embodiment.

FIG. 1C is an example view of the device shown in FIG. 1A in a deployed configuration for accessing the vehicle, according to an embodiment.

FIGS. 2A and 2B are views of a vehicle access device in a folded and deployed configuration, respectively, according to an embodiment.

FIG. 3 is an example diagram of a member of a vehicle access device, according to an embodiment.

FIGS. 4A-4C are views of a first elongated portion and a second elongated portion of a member of a vehicle access device, according to an embodiment.

FIG. 5A is a view of a member and a base of a vehicle access device when the member is not extended, according to an embodiment.

FIG. 5B is a view of a member and a base of a vehicle access device when the member is extended, according to an embodiment.

FIGS. 6A-6D are views of an engagement portion of a vehicle access device coupled to a striker, according to an embodiment.

FIGS. 6E-6G are views of another implementation of the engagement portion of a vehicle access device coupled to a striker, according to an embodiment.

FIGS. 6H-6J are views of an engagement portion at various angular positions relative to a striker, according to an embodiment.

FIG. 6K is a perspective view of an engagement portion, according to an embodiment.

FIG. 6L is a perspective view of a striker, according to an embodiment.

FIGS. 6M-6N are example implementations of an engagement portion including protrusions, according to embodiments.

FIGS. 7A-7C are views of a central joint of a vehicle access device, according to an embodiment.

FIG. 8 is an example locking mechanism for locking the central joint angle of a vehicle access device, according to an embodiment.

FIGS. 9A-9C are views of a base coupled to a member of a vehicle access device via a base joint, according to an embodiment.

FIGS. 10A-10D show example deployed configurations of a vehicle access device, according to an embodiment.

FIGS. 11A and 11B are views of a vehicle access device having an engagement joint, according to an embodiment.

FIGS. 12A and 12B are views of a vehicle access device having a securing clip, according to an embodiment.

FIG. 13 is an example of a vehicle access device having a base with multiple legs, according to an embodiment.

FIG. 14 is another example of a vehicle access device having a base with multiple legs, according to an embodiment.

FIG. 15 is an example of a vehicle access device having two members, according to an embodiment.

FIG. 16 is an example method of placing a vehicle access device in a deployed configuration, according to an embodiment.

FIG. 17 is an example method of placing a vehicle access device in a folded configuration, according to an embodiment.

FIG. 18 is an example schematic of a vehicle access device, according to an embodiment.

FIGS. 19A-19C are views of an exemplary vehicle access device, according to an embodiment.

FIGS. 20A-20D are views of exemplary engagement portions, according to an embodiment.

FIGS. 21A-21C are views of an exemplary connector body, according to an embodiment.

FIGS. 22A-22C are views of an exemplary hinge assembly, according to an embodiment.

FIGS. 23A-23C are views of an exemplary hinge assembly, according to an embodiment.

FIG. 24 is a view of a vehicle access device in a folded configuration, according to an embodiment.

FIG. 25 is a block diagram of a method for deploying a vehicle access device, according to an embodiment.

### DETAILED DESCRIPTION

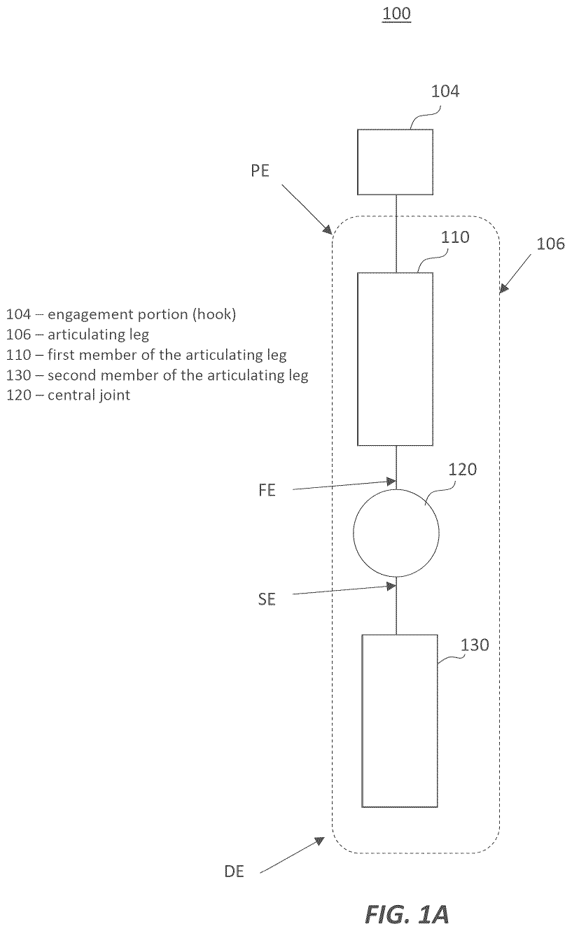

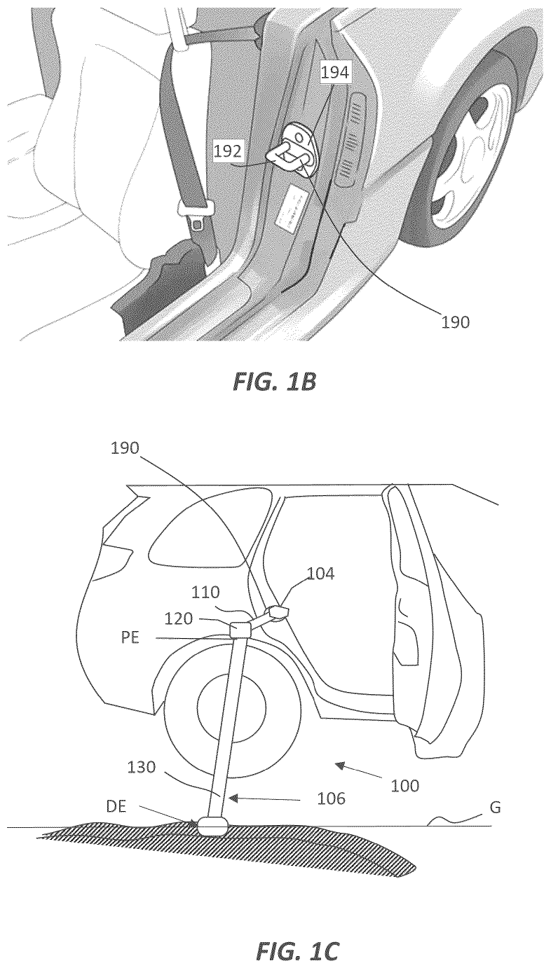

Aspects of the present disclosure are related to a device for assisting a user with vehicle access. In various embodiments discussed herein, the device is configured to assist a user in getting into and out of the vehicle. FIG. 1 shows an example schematic of a device 100 for assisting a user with getting into and out of a vehicle, according to embodiments. The device 100 includes an engagement portion 104 and an articulating leg 106 coupled to the engagement portion 104. For instance, a proximal end PE of the articulating leg 106 is coupled to of the engagement portion 104, as shown in FIG. 1A. The engagement portion 104 may be welded to the proximal end PE of the articulating leg 106, or fixedly coupled to the proximal end PE using any other suitable means, such as screws, bolts, rivets, glue, and the like. Alternatively, in some cases, the engagement portion 104 may be configured to decouple from the proximal end PE of the articulating leg 106. For example, the engagement portion 104 may be decoupled (e.g., unscrewed, unbolted, etc.) from the articulating leg 106 and replaced. This can be useful for replacing selective components of the device 100, e.g., if the engagement portion 104 is damaged, or a different engagement portion needs to be selected to match a particular configuration of a car (or other compartment) that is user getting in and out of.

The engagement portion 104 is configured to engage a striker, located in a doorframe of a vehicle, and to hold the device 100 in a fixed relationship relative to the striker. The striker of a vehicle (herein, also referred to as a door striker or simply a striker) is a U-shaped clip that serves as the anchor for the door latch. The door striker is typically installed in a door frame (e.g., a door jamb) and is aligned with a door latch so that the latch catches onto the striker when the door of the vehicle closes. An example view of the striker 190 located in the door frame of a vehicle is shown in FIG. 1B. The striker 190 is fixedly mounted to an interior of a vehicle door frame and includes a U-shaped member 192 fixedly mounted or integrally mounted to a based plate 194. Importantly, because the striker 190 of the vehicle is designed to keep a door of the vehicle closed, even in high impact situations (e.g., including those associated with accidents), the striker 190 of a vehicle is designed to bear high forces and loads. As such, the striker 190 is well suited for use with the mobility access devices such as device 100 described herein.

The articulating leg 106 of the device 100 is an extended portion of the device 100 for supporting a weight of a user when user exits or enters the vehicle. The articulating leg 106 includes a first member 110 pivotably connected to a second member 130 at a central joint 120. The first member 110 includes the proximal end PE at which it is coupled to the engagement portion 104. The distal end of the first member 110 is connected to a first end FE of the central joint 120, and the proximal end of the second member 130 is connected to a second end SE of the central joint 120, as shown in FIG. 1A.

In various implementations, the first member 110 and the second member 130 may be elongated members formed from a durable material and having a structure such that the articulating leg 106 is capable of supporting at least a partial weight of a person when a person leans on the articulating leg 106 at various possible leaning angles. Further, in various implementations, the articulating leg 106 is configured to support the partial weight of a user when the engagement portion 104 is engaged to the striker of a vehicle. In some cases, the articulating leg 106 may support at least 75% weight, 60% weight, 45% weight, 30% weight or 15% weight of the user. In some cases, the articulating leg 106 is configured to support 300 pounds (lb ), 280 lb, 260 lb, 240 lb, 220 lb, 200 lb, 180 lb, 160 lb, 140 (lb ), 120 lb, 100 lb, and the like. In some cases, the articulating leg 106 is configured to support more than 300 lb (e.g., 400 lb). In some cases, the articulating leg is configured to support a weight in a range of 400-50 lb, including all the values and ranges in therebetween. In some implementations, the materials for forming the first member 110 and/or the second member 130, may include metal (e.g., aluminum, aluminum alloys, steel, steel alloys, titanium, and the like), wood, plastic, such as PVC, ceramics, fiberglass, carbon fiber, combination thereof, and the like. Further, structures used for forming the first member 110 and/or the second member 130 includes cylindrical structures, I-beam shape structures, combination thereof, and the like. The cylindrical structures may have a circular cross-section, rectangular cross-section, triangular cross-section, hexagonal cross-section, combination thereof, or any other suitable cross-section. In some cases, the structures for forming the first member 110 and/or second member 130 may be hollow, partially hollow (e.g., include suitable internal structure, such as internal meshes), or solid. In some cases, structures of several different cross-sections may be used in combination to form the first member 110 and/or second member 130. Additionally, structures formed from various materials, may be used in any suitable combination to form the first member 110 and/or second member 130.

As described above, the first member 110 and the second member 130 are configured to be connected by a central joint 120. The central joint 120 allows the second member 130 to be pivotally connected to the first member 110, such that the second member 130 can be oriented at an angle to the first member 110. In one implementation, the central joint 120 is configured such that the first member 110 and the second member 130 can form any suitable angle in a range of 0 to 360 degrees about an axis of rotation, including all values and sub-ranges therebetween. In some implementations, a first member 110 and the second member 130 may form an angle in a range of 0 to about 180 degrees about an axis of rotation. When the first member 110 and the second member 130 forms no angle (or substantially no angle), the device 100 can be in a folded configuration. In the folded configuration, the first member 110 is positioned substantially parallel to the second member 130.

Further, when an angle between the first member 110 and the second member 130 is substantially larger than zero (e.g., the angle between the first member 110 and the second member 130 is about 90 degrees, about 100 degrees, about 110 degrees, about 120 degrees, about 130 degrees, about 140 degrees, and the like, including all values and sub-ranges therebetween), the device 100 can be in a deployed configuration.

FIG. 1C shows the device 100 when the device 100 is in a deployed configuration. In the deployed configuration of the device 100, the engagement portion 104 can be coupled to the striker 190 located in the door frame of a vehicle, and the first member 110 and second member 130 of the articulating leg 106 form an angle, which can be, for example, an obtuse or right angle. For example, the angle may be in a range of about 90 to 150 degrees, including all the values and ranges in between. As shown in FIG. 1C, a distal end DE of the second member 130 is configured to contact a ground surface G, while the proximal end PE of the second member 130 is coupled to the central joint 120. Further, the first member 110 extends between the striker 190 and the central joint 120. In some implementations, the first member 110 may be positioned substantially parallel to the ground surface G, while the second member 130 may be positioned substantially perpendicular to the ground surface G, and extended between the central joint 120 and a location at the ground surface G. In some cases, the first member 110 may not be substantially parallel to the ground surface G, but instead, form a positive or a negative angle to the ground surface G. The positive angle indicates that the engagement portion 104 coupled to the striker 190 is higher from the ground surface G than the central joint 120, and the negative angle indicates that the engagement portion 104 coupled to the striker 190 is lower from the ground surface G than the central joint 120. In one example use of the device 100, the first member 110 may form about a 5-degree angle to the ground surface G, about a 10-degree angle, about a 15-degree angle, about a 20-degree angle, or any other suitable angle in a range of about 0 to 60 degrees, including all the ranges and values in between. In another example use of the device 100, the first member 110 may form about a negative 5-degree angle to the ground surface G, about a negative 10-degree angle, about a negative 15-degree angle, about a negative 20-degree angle, or any other suitable angle in a range of about 0 to negative 60 degrees, including all the ranges and values in between.

Similarly, in some cases, the second member 130 may not be positioned substantially perpendicular to the ground surface G but instead form a positive or a negative angle to the ground surface G. The positive angle indicates that the central joint 120 is closer to the door frame of the vehicle than the distal end of the articulating leg 106, and the negative angle indicates that the central joint 120 is further away from the door frame of the vehicle than the distal end of the articulating leg 106. In one example use of the device 100, the second member 130 may form about a 5-degree angle to the ground surface G, about a 10-degree angle, about a 15-degree angle, about a 20-degree angle, or any other suitable angle in a range of about 0 to 60 degrees, including all the ranges and values in between. In another example use of the device 100, the second member 130 may form about a negative 5-degree angle to the ground surface G, about a negative 10-degree angle, about a negative 15-degree angle, about a negative 20-degree angle, or any other suitable angle in a range of about 0 to negative 60 degrees, including all the ranges and values in between.

In various implementations, when the device 100 is in a deployed configuration the first and second members lie in the same plane that is perpendicular to the ground surface G. Further, the first and the second members are configured to pivot within that plane.

The central joint 120 is configured to include a locking mechanism for locking a position of (i.e., securing in a fixed matter) the first member 110 relative to the second member 130 at a selectable fixed angle (herein, such angle is referred to as a central joint angle). Further, the locking mechanism can be unlocked to unlock the central joint angle.

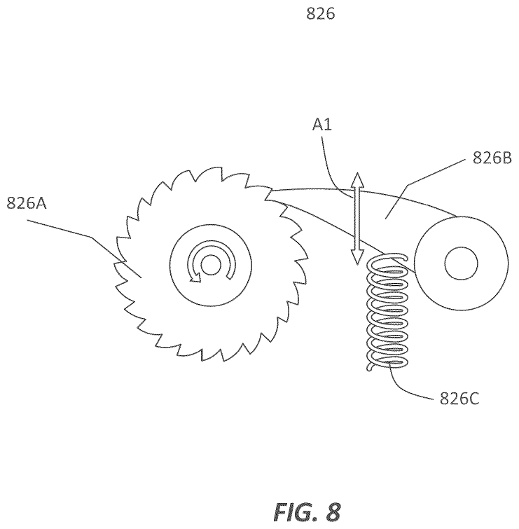

In an example implementation, the central joint angle locking may result in any suitable central joint angle. For example, the central joint angle may be about 0 degrees (e.g., when the first member 110 and the second member 130 are parallel to each other), about 80 degrees, about 90 degrees, about 100 degrees, about 110 degrees, about 120 degrees, about 130 degrees, about 140 degrees, about 150 degrees, about 160 degrees, about 170 degrees, or about 180 degrees. In some cases, the central joint angle may be in a range of 0 to about 180 degrees, including all the values and ranges in between. Further details of a locking mechanism for locking the central joint angle are discussed below in relation to FIG. 8.

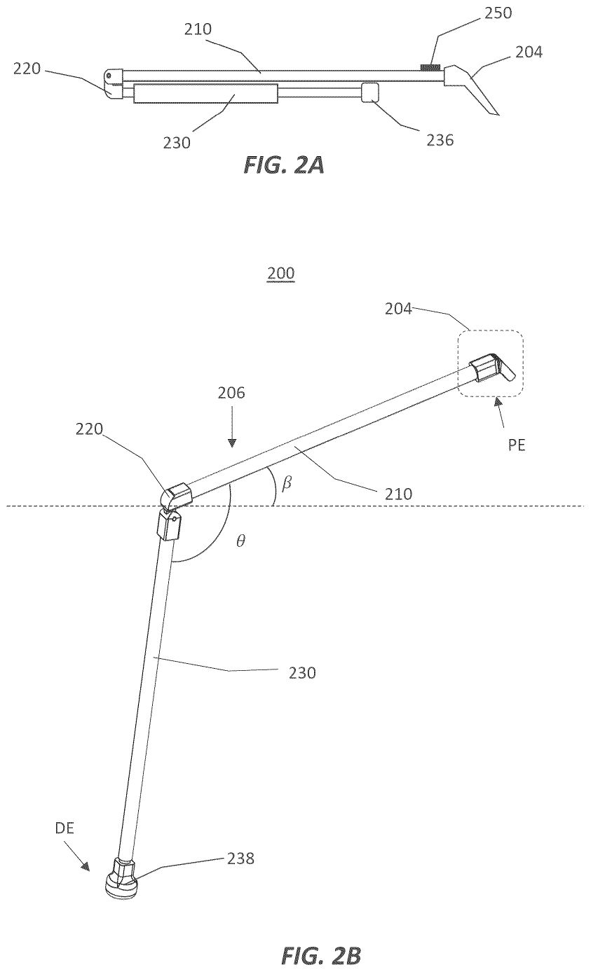

FIG. 2A shows a device 200 in a folded configuration and FIG. 2B shows the device 200 in a deployed configuration, according to embodiments. The device 200 can be for assisting a user with getting into and out of a vehicle. The device 200 may be the same as or similar to the device 100 as shown in FIG. 1A. For instance, various components of the device 200 may be the same as or similar to the respective components of the device 100. For example, the device 200 includes an engagement portion 204 located at a proximal end PE of the device 200, and an articulating leg 206. The articulating leg 206 includes a first member 210, a second member 230, and a central joint 220 configured to pivotably couple the first member 210 and the second member 230. As shown in FIG. 2B, the first member 210 and the second member 230 are coupled via the central joint 220 such that there is a central joint angle θ formed between the first member 210 and the second member 230. As shown in FIG. 2A, in the folded configuration, the first member 210 is positioned substantially parallel to the second member 230 (e.g., the central joint angle θ is zero in the folded configuration). Further, as shown in FIG. 2B, in the deployed configuration, in some cases, the central joint angle θ may be larger than about 90 degrees. In some configurations of the device 200, in the deployed configuration, a central joint angle θ may be selected such that the first member 210 is placed substantially parallel to a ground surface (e.g., the locking mechanism may be configured to lock the first member 210 relative to the second member 230 when the first member 210 is substantially parallel to the ground surface). In some cases, a user may visually determine that the first member 210 is placed substantially parallel to the ground surface, and in other cases, device 200 may include an indicator to indicate to the user that the first member 210 is substantially parallel to the ground surface (e.g., the indicator may be a level indicator, or any other suitable device for performing a similar function). In some cases, when the indicator is a level indicator, the level indicator may be a part of the first member 210. Alternatively, in some cases, the first member 210 may form an angle with the ground surface (e.g., the angle β, as shown in FIG. 2B, between the first member and the ground surface may be a few degrees or a few tens of degrees. In some cases, the angle β may be about 5 degrees, about 10 degrees, about 15 degrees, about 20 degrees, about 25 degrees, about 30 degrees, and the like. In some cases, the angle β may range between 0-40 degrees including all the values and ranges in between.

In some embodiments, the device 200 may include a deployment mechanism 250, as shown in FIG. 2A, configured to transition the device from the folded configuration to the deployed configuration. For instance, the deployment mechanism 250 is configured to facilitate pivoting the second member 230 relative to the first member 210. In one example embodiment, the deployment mechanism 250 may include a spring-based mechanism configured to rotate the second member 230 relative to the first member 210 when the device is in a folded configuration, and a button configured to activate the spring-based mechanism to transition the device from the folded configuration to a deployed configuration upon user pressing the button. In some embodiments, the deployment mechanism 250 can include electrical components, e.g., a motor, along with mechanical components that rotate and/or translate the first member 210 relative to the second member 230. It should be noted that in some cases, the deployment mechanism 250 may not be present and a user may deploy the device 200 by manually pivoting the second member 230 relative to the first member 210 until the activation of the locking mechanism for the central joint.

Additionally, the device 200 includes a base 238 configured to contact the ground surface G, when a distal end DE of the device 200 is placed onto the ground surface G. The base 238 may be formed from a material that provides adequate traction (e.g., a traction that prevents a slippage of the device 200 with respect to the ground surface G when a user places at least some of his/her weight onto the device 200). For instance, the base 238 may be formed from anti-slip rubber, plastic, or any other material that can engage with the ground surface G and provide a gripped or high friction engagement.

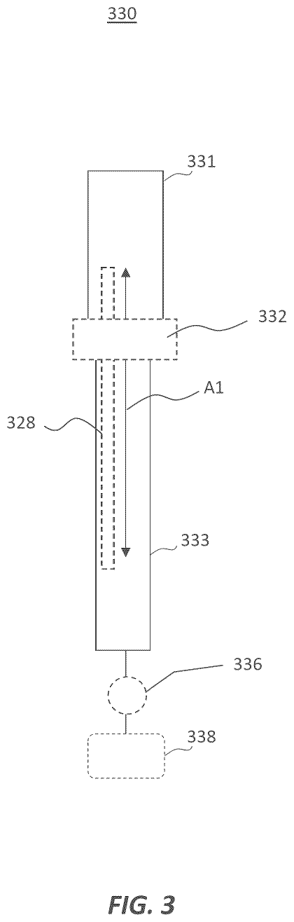

FIG. 3 shows an example embodiment of a second member 330 of a device 300 for providing mobility assistance, e.g., in getting in and out of a vehicle, according to embodiments. The device 300 can include a first elongated portion 331 and a second elongated portion 333, a base 338, and optionally a base joint 336, a second member locking mechanism 332, and an extending mechanism 328. In the example embodiment shown in FIG. 3, the second elongated portion 333 may be configured to move relative to the first elongated portion 331, as schematically indicated by arrow A1 in FIG. 3. In the example embodiment, the first elongated portion 331 is slidably connected to the second elongated portion 333. In some implementations, the second elongated portion 333 may be disposed at least partially within the first elongated portion 331 (e.g., within a channel defined by the first elongated portion 331), and in other implementations, the first elongated portion 331 may be disposed at least partially within the second elongated portion 333 (e.g., within a channel defined by the second elongated portion 333).

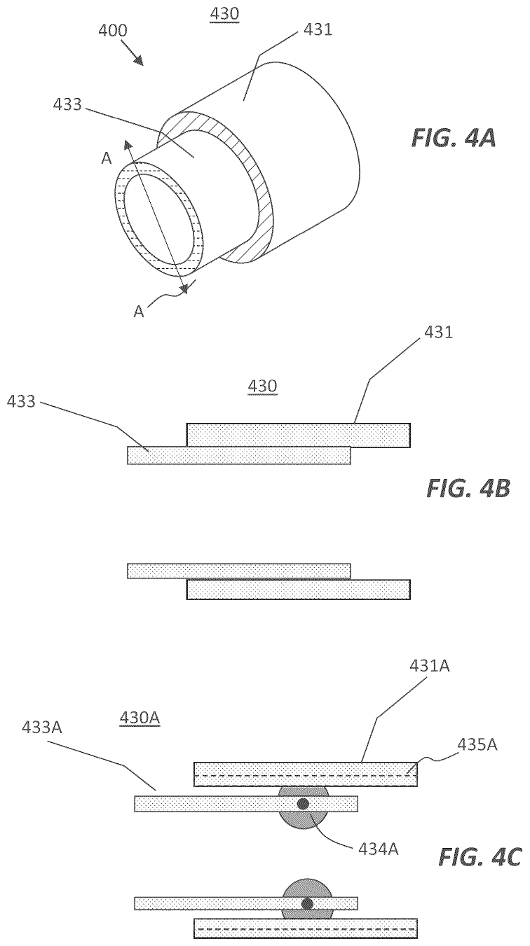

FIGS. 4A-4B depict different views of an example embodiment of a second member 430 of a device 400 for providing mobility assistance, e.g., in getting in and out of a vehicle. The second member 430 may be structurally and/or functionally similar to other second members described herein, including, for example, second member 330. The second member 430 includes a first elongated portion 421 in a form of a cylinder with a circular cross-section (e.g., a pipe), and a second elongated portion 433 in a form of another cylinder with a circular cross-section (e.g., a pipe) that has a smaller diameter such that the second elongated portion 433 fits within the first elongated portion 431. FIG. 4B shows a cross-sectional view along a plane A-A (the plane A-A is shown in FIG. 4A) of the first elongated portion 431 and a second elongated portion 433. In the example implementation, the first elongated portion 431 is slidably connected to the second elongated portion 433 (e.g., the second elongated portion 433 may slide into the first elongated portion 431 or out of the first elongated portion 431 by a selected distance). In various implementations, the first elongated portion 431 and the second elongated portion 433 may form a telescopically adjustable shaft.

FIG. 4C shows an example variation of a second member 430A, wherein the second elongated portion 433A includes wheels 434A for facilitating sliding of the second elongated portion 433A. The wheels 434A may be configured to slide within grooves schematically shown by dashed line 435A in FIG. 4C. The inclusion of wheels 434A may reduce friction between the second elongated member 433A and the first elongated member 433A. It should be noted that any other suitable approaches may be used for reducing the frictional forces (e.g., ball bearings, cylinder bearings, lubricants, and the like may be used) between an example first elongated portion and a second elongated portion. As described above, while it is shown in FIGS. 4A-4B that the second elongated portion 433 is disposed within the first elongated portion 431, in other implementations a first elongated portion may be disposed within a second elongated portion.

Returning to FIG. 3, the device 300 optionally includes the extending mechanism 328. The extending mechanism 328 can be configured to automatically adjust a distance d by which the second elongated portion 333 is moved relative to the first elongated portion 331 based on a value of a central joint angle (e.g., the central joint angle θ, as shown in FIG. 2B). For instance, if the device 300 is in the folded configuration (e.g., the central joint angle θ is zero), then the second elongated portion 333 may be disposed substantially withing the first elongated portion 331 (or the first elongated portion 331 may be disposed substantially within the second elongated portion 333), and when the device 300 is in a deployed configuration (e.g., central angle θ is at a target θ_{target} value which may be, for instance, greater than 90 degrees), the second elongated portion 333 may be moved relative to the first elongated portion 331 by a target distance d=d_{target}. In some cases, the extending mechanism 328 may continuously couple the central joint angle θ and the distance d. For example, the extending mechanism 328 may be configured to cause the distance d to be directly proportional to the central joint angle θ, or cause distance d to depend on central joint angle θ in any other suitable way d(θ). For instance, d(θ) may initially increase until θ is about 90 degrees, and then decrease when θ is larger than about 120 degrees. In some cases, the distance d(θ) may have a first value d₁, when θ=0, a second value d₂ larger than d₁ when θ is in a range of about 60 to 120 degrees and have a third value d₃ which is smaller than d₂ but larger than d₁ when θ is about 180 degrees. For instance, the third value d₃ may be selected such that the device 300 may be used as a walking cane, when the central joint angle θ is about 180 degrees. In various cases, the respective lengths of the first elongated portion 331 and the second elongated portion 333 may be selected, such that the device 300 may be used as a walking cane when the central joint angle θ is selected to be about 180 degrees (e.g., the combined length of the first member 331 and the second member 333 may result in the device 300 having a length of a walking cane when the central joint angle θ is selected to be about 180 degrees).

The extending mechanism 328 may be any suitable mechanical or electrical mechanism for adjusting the distance d. For example, the extending mechanism 328 may be any suitable mechanism for converting a rotational motion of the first member 310 moving relative to the second member 330 by the central joint angle θ, into a translational motion for moving the second elongated portion 333 relative to the first elongated portion 331. Some example implementations of extending mechanisms 328 include rack and pinion, cam and follower, and the like.

The device 300 optionally includes the second member locking mechanism 332 for locking the second elongated portion 333 relative to the first elongated portion 331. The second member locking mechanism 332 may lock the second elongated portion 333 in place after the second elongated portion 333 is moved relative to the first elongated portion 331 by a selected distance. Alternatively, in some variations, a first elongated portion 331 may be configured to be locked in place relative to the second elongated portion 333 when the first elongated portion 331 is moved relative to the second elongated portion 333 by a selected distance.

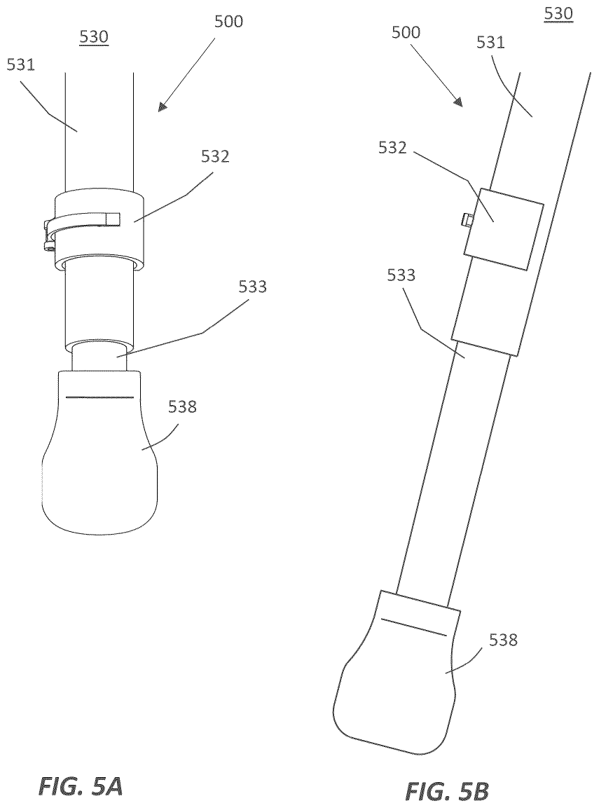

An example second member locking mechanism 532 is shown in FIGS. 5A and 5B for a second member 530 of a device 500 for providing mobility assistance, e.g., in getting in and out of a vehicle. The device 500 may be the same as or similar to the device 300 as shown in FIG. 3. For example, the second member of device 500 includes a first portion 531 and a second portion 533 slidably connected to the first portion. Further, the device 500 includes a base 538 which may be similar to a base 338 of the device 300. The second member locking mechanism 532 may be any suitable locking mechanism for locking the second portion 533 relative to the first portion 531. For instance, the second member locking mechanism 531 may be a flip lock, a twist lock, a lever lock, a pin lock, a button lock, or any suitable locking mechanism (e.g., a friction-based lock, and the like).

FIG. 5A shows a configuration of the second member 530, when the second portion 533 is substantially disposed within the first portion 531, while FIG. 5B shows another configuration of the member 530, when the second portion 533 is extended out from the first portion 531. The second member locking mechanism 532 may lock the second elongated portion 533 relative to the first elongated portion 531 so as to lock a distance by which the second member 533 is extended out. In some implementations, e.g., when the second member locking mechanism 532 is a flip lock or a twist lock, the second elongated portion 533 may be locked relative to the first elongated portion 531 when the second elongated portion 533 is moved relative to the first elongated portion 531 by any suitable distance. Alternatively, in some other implementations, the second member locking mechanism 532 may lock the second elongated portion 533 relative to the first elongated portion 531 when the second elongated portion 533 is moved relative to the first elongated portion 531 by a preset distance (or a set of preset distances).

In some configurations, a second elongated portion (e.g., the second elongated portion 333 or 533) is moved relative to a first elongated portion (e.g., the first elongated portion 331 or 551) such that the resulting length of the second member (e.g., the second member 330 or 530) is about the same as a striker height, i.e., the distance from the location of a striker (e.g., the striker 190, as shown in FIG. 1B) and a ground surface (e.g., the ground surface G, as shown in FIG. 1C). In such a configuration, if a central joint angle (e.g., the central joint angle θ, as shown in FIG. 2B) is about 90 degrees, then the first member (e.g., first member 210, as shown in FIG. 2A) is about parallel to the ground surface G. In some other configurations, the resulting length of the second member may be selected to be smaller or larger than the striker height. For example, the length of the second member may be selected to be about 70 percent, 80 percent, 90 percent, 110 percent, 120 percent, or 130 percent of the striker height. In some cases, the resulting length of the second member may be selected to be in a range between about 5-150 percent of the striker height including all the values and ranges in between.

In some cases, the length of the first elongated portion 531 is about equal or greater than the length of the second elongated portion 533, such that the second elongated portion 533 may be fully inserted into the first elongated portion 531. Alternatively, in other implementation, when the first elongated portion 531 is configured to be inserted into the second elongated portion 533, the length of the second elongated portion 533 may be about equal or greater than the length of the first elongated portion 531.

Further, in some implementations, the length of the first elongated portion 531 may be less than a length of a first member (e.g., the first member 210, as shown in FIG. 2B), or vice versa.

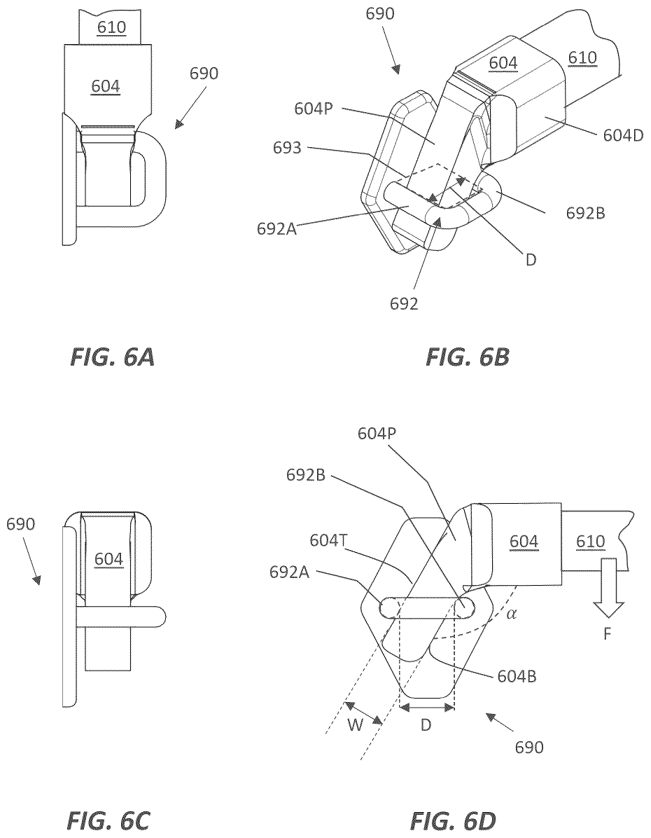

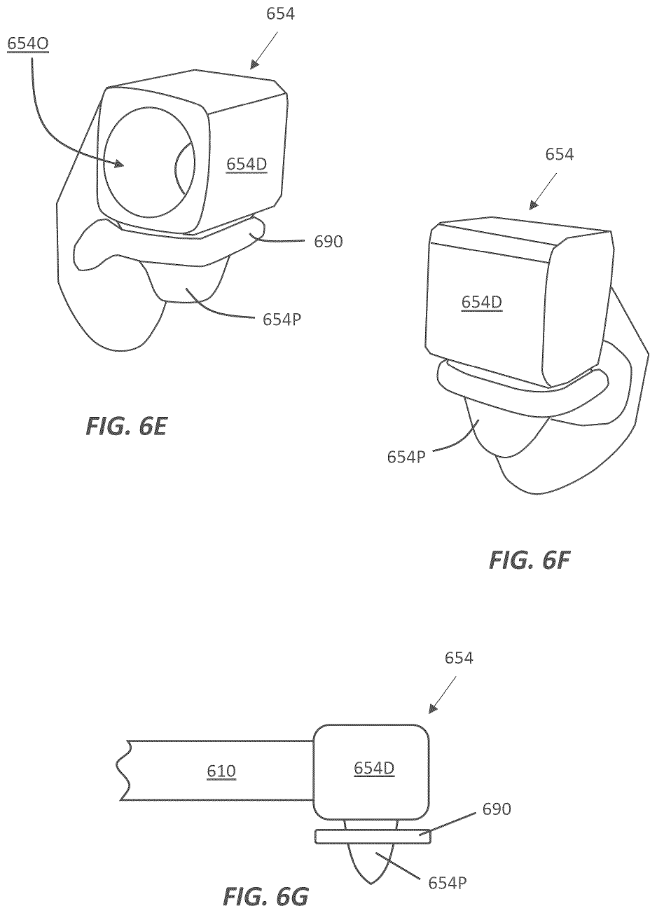

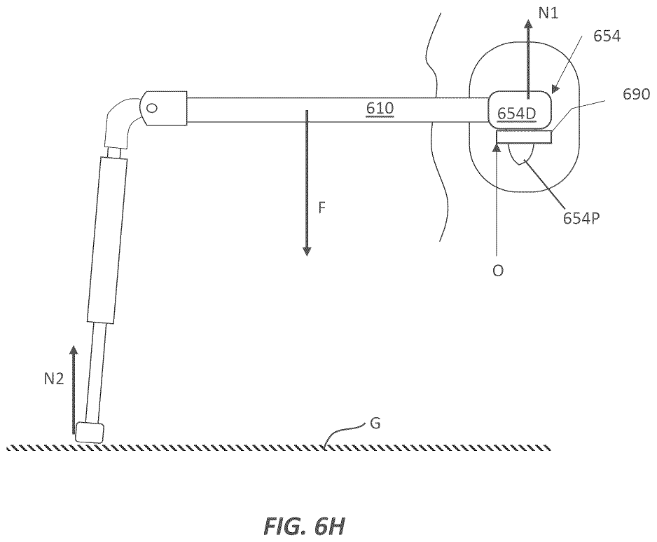

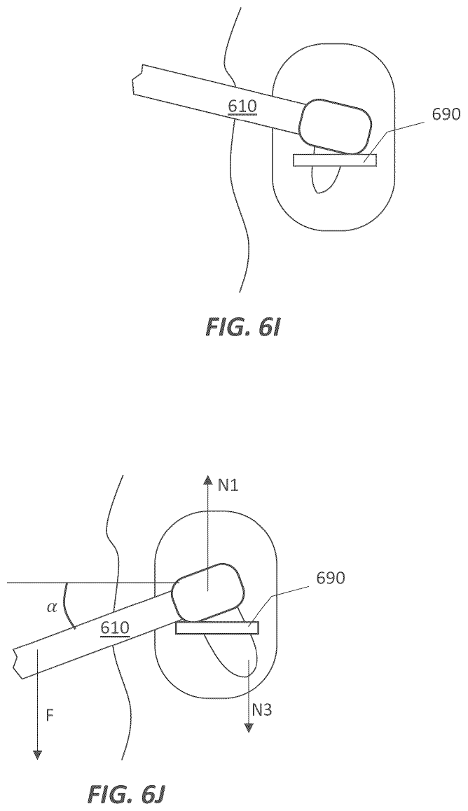

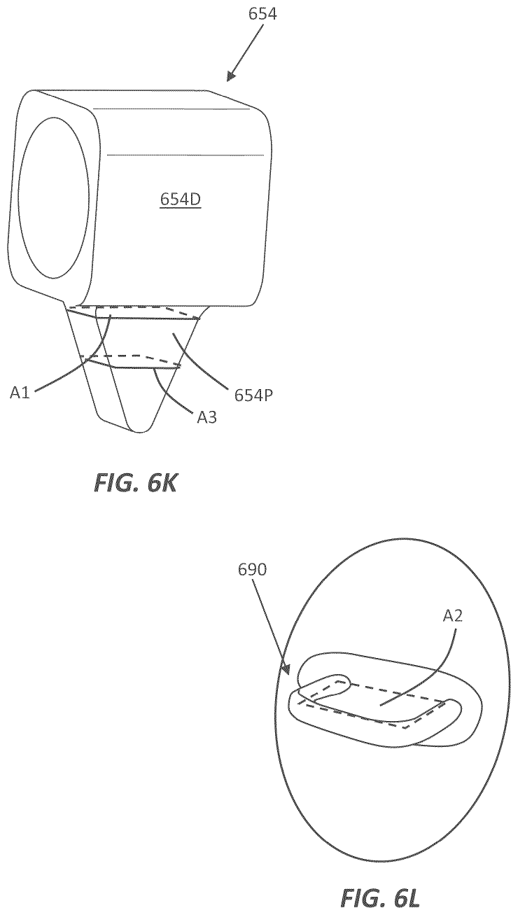

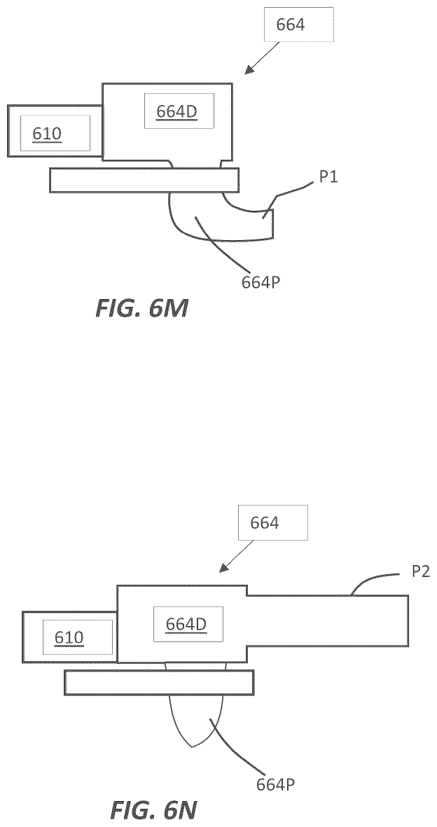

FIGS. 6A-6D depict various views of an example engagement portion 604 inserted into a striker 690, according to embodiments. For example, FIG. 6A shows a top view of, FIG. 6B shows a perspective view of, FIG. 6C shows a front view of, and FIG. 6D shows a side view of the engagement portion 604 inserted into the striker 690. The engagement portion 604 can be structurally and/or functionally similar to other engagement portions described herein (e.g., engagement portion 104, 204, etc.). The engagement portion 604 is a rigid member formed of a durable material such as metal (e.g., aluminum, stainless steel, titanium, Duralumin, and the like), plastic, ceramics, or any other material capable to withstand forces commensurable with a weight of a person. For example, in some implementation the engagement portion 604 may be configured to withstand torques on the order of a weight of a person multiplied by a length of a device for assisting a user with getting into and out of a vehicle (e.g., the engagement portion 604 may be configured to withstand a torque of about a few hundred to a few thousand Newton-meters, e.g., 2000 Newton-meter, including all sub-ranges and values therebetween).

As shown by the perspective view of the engagement portion 604 in FIG. 6B, the engagement portion 604 includes a proximal part 604P for coupling with the striker 690 and a distal part 604D that is connected to or integrated with a first member 610 (e.g., in a monolithic construction). In an example implementation, the proximal part 604 forms an angle α with the distal part 604D, as shown in FIG. 6D. The angle α is selected such that, when the proximal part 604P has a width W, and the striker 690 has a width D between a striker back portion 692A and a striker front portion 692B (note that width D is a width of a striker opening 693, as shown in FIG. 6B), as shown in FIG. 6D, the angle α is selected to be about α=acos(W/D)+90°. As can be seen from FIGS. 6B and 6D, the width W is smaller than width D, such that the proximal part 604P is configured to be inserted into the striker opening 693 at an angle α.

In various implementations, the proximal part 604 has a length commensurate to extend fully through the U-shaped member 692 of the striker 690 (as shown in FIG. 6B). The proximal part 604P of the engagement portion 604 includes a top surface 604T and a bottom surface 604B, as shown in FIG. 6D (herein, the top surface 604T is also referred to as the top surface of the engagement portion 604, and the bottom surface 604B is also referred to as the bottom surface of the engagement portion 604). The engagement portion 604 is configured to engage with the striker 690, such that the top surface 604T is placed under and adjacent to the striker back portion 692A, and the bottom surface 604B of the engagement portion 604 is placed over and adjacent to the front portion 692A, thereby the engagement portion 604 engages the striker 690. Further the engagement portion 604 can be removed from the striker 690 by retracting the proximal part 604P from the opening 693.

FIGS. 6E-6G show another implementation of an engagement portion 654 for engaging with the striker 690. The engagement portion 654 includes a proximal part 654P for coupling with the striker 690 and a distal part 654D that is connected to or integrated with the first member 610 (e.g., in a monolithic construction). In an example implementation, the proximal part 654P is located at the bottom of the distal part 654D and is positioned to be inserted into the striker 690 as shown in FIGS. 6E and 6F. In some cases, the engagement portion 654 may be monolithically attached to the first member 610 at the distal part 654D. Alternatively, in certain implementations, the engagement portion 654 may be designed to be connected to the first member 610 in a manner that permits it to be detached from the first member 610. This configuration enables the selection of an appropriate engagement portion for a specific striker. For example, in one implementation, the engagement portion 654 may include a coupling connection 6540, as shown in FIG. 6E, to which the first member 610 may be coupled. The coupling connection 6540 may be any suitable coupling for securing the first member 610 to the engagement portion 654. For instance, the coupling connection 6540 may be an opening (e.g., a threaded opening) to which the first member 610 may be attached via a threaded connection.

As shown in FIG. 6G, the distal part 654D is configured to be placed at the top of the striker 690, while the proximal part 654P is being inserted into the striker 690. When using a vehicle access device, a user applies a downward force onto the first member 610, and the striker 690 and a ground level provide a reaction force balancing the downward force.

FIG. 6H shows an example deployed configuration of a vehicle access device in which the first member 610 is substantially parallel to the ground level G. In such a configuration, the proximal part 654P of the engagement portion 654 may be tightly inserted into an opening of the striker 690 preventing any substantial movement of the engagement portion 654 relative to the striker 690. As shown in FIG. 6H, the distal part 654D may be configured to rest securely over the top surface of striker 690. FIG. 6H shows that the downward force F exerted by a user onto the first member 610 is balanced by reaction forces N1 and N2 from the ground level G1 and from the striker 690 respectively. Further, the clockwise torque created by reaction force N2 balances counterclockwise torques created by reaction force N1 and downward force F around a point of rotation O, as shown in FIG. 6H.

It should be noted that in some cases, the proximal part 654P may be designed to fit inside the opening of the striker with some room for movement. This allows for some positional and angular adjustment of the first member 610 relative to the striker 690. Such possibility of adjusting the engagement portion 654 may come at a cost of additional stresses onto the engagement portion 654. For example, FIGS. 6I and 6J demonstrate how the first member 610 can be adjusted relative to the striker 690. FIG. 6J shows that the proximal part 654P may have a size and shape to engage with the striker 690 such that the striker 690 may exert a reaction force N3 onto the proximal part 654P. The force N3 acts downwards, opposite to the reaction force N1 exerted on the distal part 654D. When the first member 610 is inclined at a predetermined angle α relative to the horizontal direction, the striker 690 exerts the reaction force N3 on the proximal part 654P. The presence of the reaction force N3 reduces the torques caused by reaction force N1 and a downward force F (as shown in FIG. 6J) exerted by the user on the first member 610. Note that without the reaction force N3, the torques from forces F and N1 are balanced by a torque due to the reaction force N2 from the ground level G (as shown in FIG. 6H) onto the vehicle access device at the point where it touches the ground level.

FIG. 6K shows a perspective view of the engagement portion 654, while FIG. 6L shows a perspective view of a section of the striker 690, having an opening with a cross-section A2. As shown in FIG. 6K, the proximal part 654P may be in a form of a substantially rectangular pyramid having an apex of the pyramid pointing away from the distal portion 654D and having a base of the pyramid adjacent to the distal portion 654D. In some cases, the base may have a cross-section Al that has smaller area than area of the cross-section A2, further the cross-section Al may be shaped such that when proximal part 654P is inserted into the opening of the striker 690, the distal portion 654D comes in a contact with a top surface of the striker 690 (e.g., the proximal portion 654P is being fully inserted into the opening of striker 690). In some cases, for cars with small striker cross-sections A2, the proximal portion 654P may not be fully inserted into the striker 690 opening and may be partially inserted (e.g., the proximal portion 654P may be inserted to the striker 690 up to a cross-section identified by A3 in FIG. 6K). It can be desirable to have the proximal portion 654P have a tapered structure such that the proximal portion 654P can fit into a variety of strikers (e.g., strikers have different sized openings). In use, the proximal portion 654P can be placed through the opening of the striker until it fits snugly within the opening such that the engagement portion 654 securely holds the vehicle access device relative to the striker and does not move while a user is applying forces on the vehicle access device. It should be noted that proximal part 654P in a form of an inverted rectangular pyramid is only one possible example and various other shapes and sizes for the proximal part may be used in some implementations. For example, the proximal part may be substantially a cone with a circular cross-section, may be a parallelepiped, or any other suitable shape allowing for the proximal part to be at least partially inserted into the striker 690. Additionally, the proximal part may include securing elements (e.g., movable clips, protrusions, etc. to further secure the engagement portion to the striker 690). For instance, FIG. 6M shows one possible engagement portion 664 having a proximal part 664P with a protrusion P1. Further, in some implementations, a distal portion 664D of the engagement portion 664 may have balancing extending elements/protrusions P2, as shown for example in FIG. 6N.

In certain instances, a proximal part of an engagement portion of the vehicle access device may be designed to be movable. To illustrate, it could be set up to move in and out of an aperture in a distal part of the engagement portion, thereby enabling the vehicle access device to function as a cane. In this scenario, the distal part would act as the handle for the cane, while the proximal part could retract into the opening of the distal part, resulting in a more comfortable grip without any protruding elements, such as the proximal part.

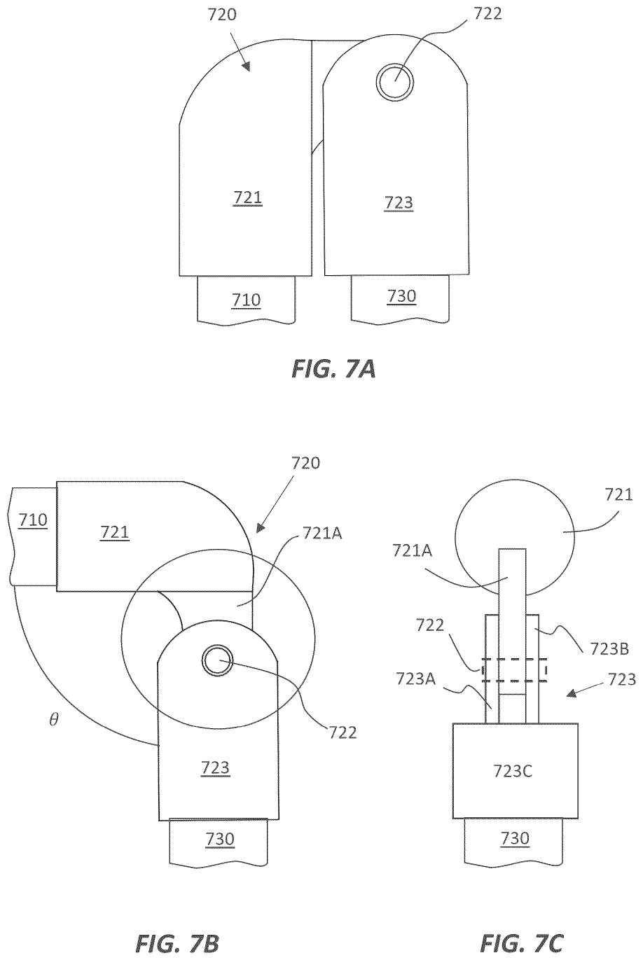

FIGS. 7A-7C show example configurations of a central joint 720 for pivotably connecting a first member 710 to a second member 730 of a device for providing mobility assistance, e.g., in getting in and out of a vehicle. FIG. 7A shows the central joint 720 in a folded configuration and FIGS. 7B and 7C shows the central joint 720 in a deployed configuration. FIG. 7B shows a side view of the central joint 720 in the deployed configuration and FIG. 7C shows a front view of the central joint 720 in the deployed configuration. The joint 720 may include a first central joint member 721 pivotably coupled to a second central joint member 723. The first central joint member 721 is configured to couple to the first member 710, while the second central joint member 723 is configured to couple to the second member 730. For instance, the first member 710 may be coupled to the first central joint member 721 at its distal end while the proximal end of the first member 710 is coupled to an engagement portion. Further, the proximal end of the second member 730 may be coupled to the second central joint member 723, while a distal end of the second member 730 may be coupled to a base.

In the folded configuration, the first central joint member 721 and the second central joint member 723 are positioned such that the first member 710 and the second member 730 are substantially parallel to each other (e.g., the central axis for these members are substantially parallel to each other). In the deployed configuration (or unfolded configuration), the first central joint member 721 and the second central joint member 723 are positioned such that the first member 710 and the second member 730 form a central joint angle θ between each other. In the example embodiment, as shown in FIG. 7B, the central joint angle θ is about 90 degrees, but it should be understood, as described above, that central joint angle θ may be smaller or larger than 90 degrees.

In an example implementation, the second central joint member 723 includes a pair of central joint shoulders 723A and 723B positioned as shown in FIG. 7C. The first central joint member 721 includes a central joint protruding member 721A for connecting to the central joint shoulders 723A and 723B via a pin 722. For example, the central joint protruding member 721A may include a first hole and central joint shoulders 723A and 723B may include respective second and third holes, such that, when the central joint protruding member 721A is placed between the central joint shoulders 723A and 723B and the first hole is aligned along the same axis with the second and third hole, the pin 722 may be inserted through the second, the first, and the third hole, thereby rotatably attaching the first central joint member 721 to the second central joint member 723.

In some implementations, as described above in relation to central joint locking, the central joint 720 includes a locking mechanism (not shown in FIGS. 7A-7C but described with respect to FIG. 8) for locking the first central joint member 721 in a fixed position relative to the second central joint member 723. Further, in some implementations, the central joint 720 may be coupled to a deployment mechanism (not shown in FIGS. 7A-7C but described with respect to FIG. 2A) for automatically pivoting the first central joint member 721 relative to the second central joint member 723.

An example rachet locking mechanism 826, shown in FIG. 8, may be used for central joint angle locking. For example, the rachet locking mechanism 826 includes a gear 826A that can be rotated in one direction (e.g., counterclockwise as shown in FIG. 8), but may not be rotated in the opposite direction when engaged to a pawl 826B. The pawl 826B may execute movements as shown by arrow A1 and may be connected to a spring 826C for facilitating coupling the pawl 826B to the gear 826A. When a device for assisting a user with a vehicle access including the rachet locking mechanism 826 is deployed, a first central joint member is rotated relative to a second central joint member by the central joint angle θ, and the gear 826A is rotated by the central joint angle θ and is locked at that angle. To unlock the selected central joint angle θ, a user may disengage the pawl 826B from the gear 826A via any suitable decoupling device (e.g., by a mechanical device which may be activated by a push of a button or any other suitable mechanical or electronic interfacing device). In an example embodiment, the pawl 826B may be configured to be disengaged until the user places the device in the folded configuration. After placing the device in the folded configuration, the pawl 826B may re-engage with the gear 826A, thereby reactivating the rachet locking mechanism.

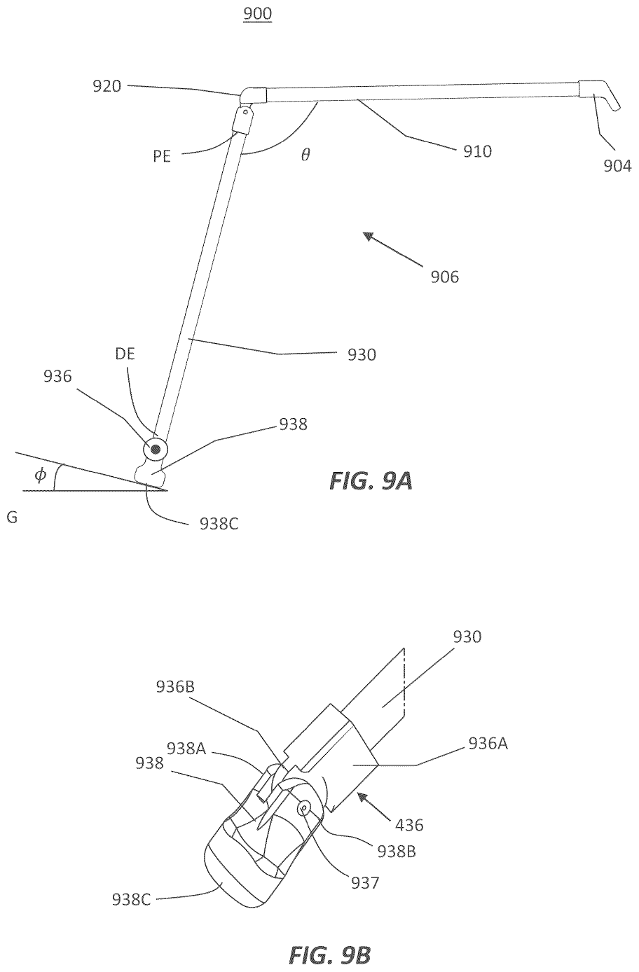

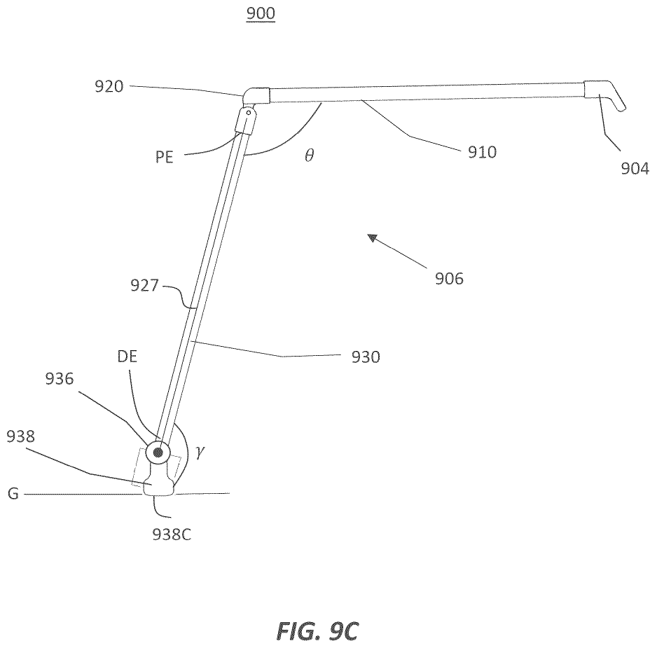

As described above with respect to FIGS. 1A-3, in various embodiments, a device for assisting a user with vehicle access may include a base disposed on a distal end of a second member. For example, FIG. 9A shows a device 900 that includes an engagement portion 904 and an articulating leg 906. The articulating leg 906 includes a first member 910, a second member 930, a central joint 920, a base 938, and a base joint 936. In some cases, the device 900 may be similar to or the same as other devices described herein (e.g., devices 100, 200, 300, etc.). While implementations of device 900 is shown to have the base joint 936, in some other implementations, the base joint 936 may be absent, and the base 938 may be disposed directly at the distal end DE (as shown in FIG. 9A) of the second member 930. In such embodiments, the base 938 can be coupled to or integrated with the second member 930 (e.g., in a monolithic construction).

FIG. 9B shows a detailed view of the base joint 936. The base joint 936 may include a base joint proximal portion 936 that is coupled with a distal end of the second member 930 and a base joint protruding member 936B rotatably coupled to the base 938 via a pin 937. In the example implementation shown in FIG. 9B, the base includes shoulders 938A and 938B between which the base joint protruding member 938B is inserted and secured by the pin 937.

FIG. 9A shows the device 900 in a deployed configuration having a central joint angle θ, which results in a base bottom surface 938C forming an angle φ with the ground surface G. Such an angle φ may not provide sufficient traction or engagement between the base 938 and the ground surface G. In various embodiments, the base 938 may be rotated relative to the second member 930, as shown in FIG. 9C, such that the base bottom surface 938C is placed flat on the ground, thereby making a base angle γ with respect to the second member 930. In the example embodiment of the device 900, in the deployed configuration, a central joint angle θ between the first member 910 and the second member 930 is configured to be fixed by a user, and a second angle between the base 938 and the second member 930 (e.g., the base angle γ) is configured to be selected to place the base bottom surface 938C of the base substantially flat on the ground surface G. In some implementations, a connecting member 927 may be present and configured to adjust the base angle γ based on a selected value of the central angle θ. For instance, when the bottom surface 938C is placed flat on the ground surface G, as shown in FIG. 9C, the angle γ is related to angle θ (assuming that the first member 910 is substantially parallel to the ground surface G) as γ=270°−θ. In some implementations, the connecting member 927 is configured to automatically adjust the angle γ when the angle θ is selected. It should be noted, that in other implementations, the device 900 may not include the connecting member 927 and the angle γ may be manually adjusted by a user (e.g., by user pressing onto the device 900 when placing his/her weight onto the first member 910 of the device 900).

FIG. 9B shows the base joint having a single axis of rotation. In some other implementations a base may be coupled to a second member using a joint that can rotate about two or more axes of rotation such that a normal drawn to a base bottom surface of the base can be perpendicular to the ground surface G. This can allow for engagement between the base and the group even when the ground surface G is uneven. Such a joint may further improve traction of the base with the uneven ground surface G. In an example embodiment, the normal drawn to the base bottom surface may form a base angle with the axis of the second member. In some implementations, the base angle may be in a range of 0 to about 20 degrees, including all the values and sub-ranges in between.

It should be noted that bottom surface 938C may form an angle φ with the ground surface G and still provide sufficient traction with the ground surface G. Further, base 938 (e.g., a bottom of base 938 may be made from a flexible material (e.g., rubber, plastic, and the like) or material configured to have some adhesion to the ground surface G (e.g., material with a large friction coefficient with respect to the ground surface G). In some cases, the overall shape of the base 938 may be selected to better adhere to the ground surface G.

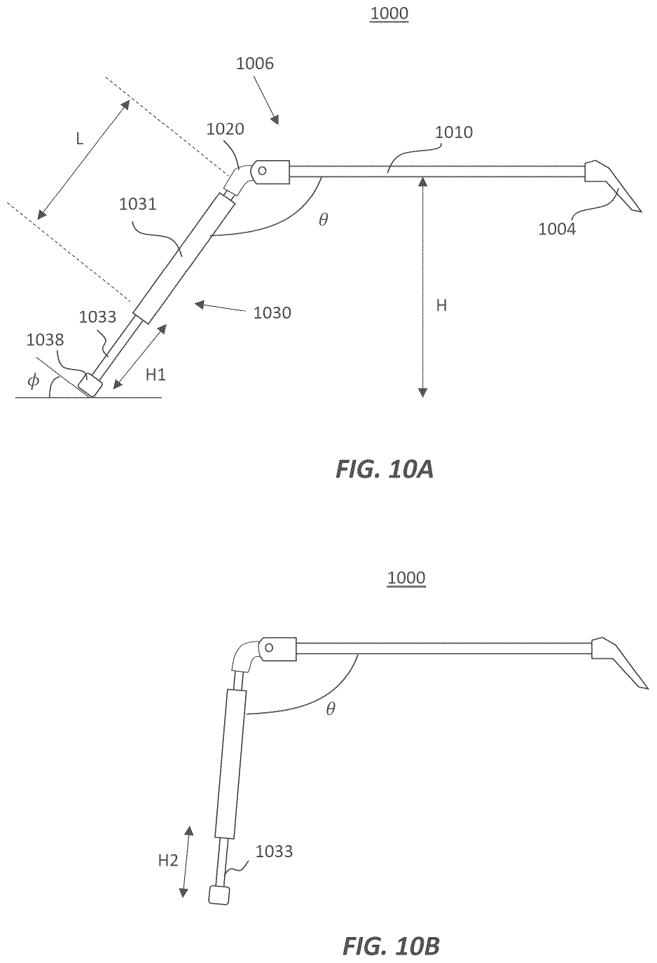

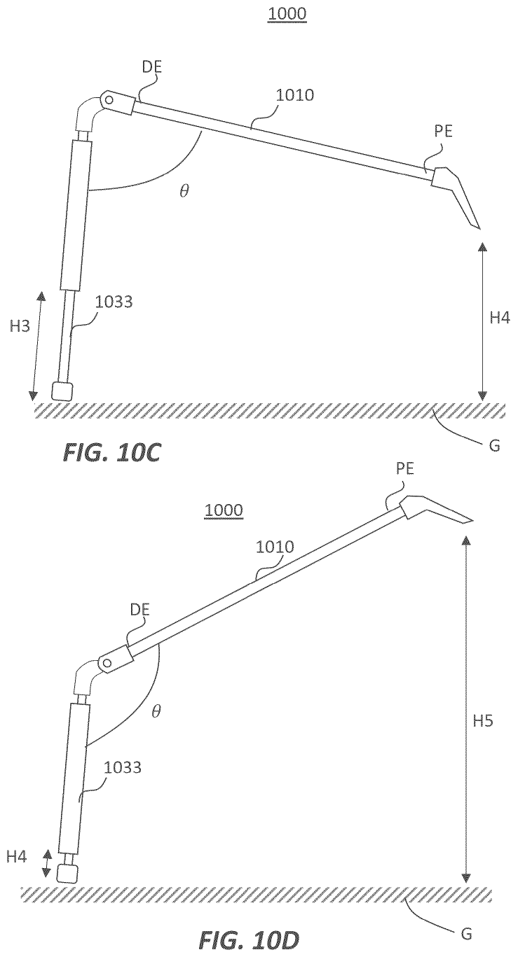

FIGS. 10A-10D show various deployed configurations of an example device 1000 for providing mobility assistance, e.g., in getting in and out of a vehicle, according to embodiments. The device 1000 can be structurally and/or functionally similar to other devices described herein (e.g., devices 100, 200, 300, etc.). For example, FIG. 10A shows the device 1000 in the deployed configuration having an engaging portion 1004 and an articulating leg 1006. The articulating leg 1006 includes a first member 1010, a second member 1030, a central joint 1020, and a base 1038. The second member 1030 includes a first elongated portion 1031 and a second elongated portion 1033. In the example embodiment, the second elongated portion 1033 is configured to extend out from the first elongated portion 1031 or retract into the first elongated portion (e.g., as show in FIG. 10A, the second elongated portion 1033 is extended out from the first elongated portion 1031 by an amount of H₁). In an example configuration shown in FIG. 10A, a central joint angle θ may be selected to be larger than 90 degrees resulting in the base 1038 making an angle φ with the ground surface G. It should be appreciated that a height H of a striker above the ground surface G, the extended amount H₁, and a length L of the first elongated portion are related to a central joint angle θ as: θ=acos(H/(H₁+L))+90°. For example, when H₁+L˜H, then θ˜90°, and when H₁+L˜2H, then θ˜150°. For instance, FIG. 10B shows H₂+L˜H and θ˜90°(herein, H₂ is an extended amount of the second elongated portion 1033, as shown in FIG. 10B).

FIG. 10C shows another deployed configuration of the device 1000 in which the first member 1010 is not parallel to the ground surface G (e.g., a distal end DE of the first member 1010 is located higher than a proximal end PE of the first member 1010). In the configuration shown FIG. 10C, the central joint angle θ is less than 90 degrees and H₃+L >H (herein, H₃ is an extended amount of the second elongated portion 1033, as shown in FIG. 10C). FIG. 10D shows another deployed configuration of the device 1000 in which the first member 1010 is not parallel to the ground surface G (e.g., a distal end DE of the first member 1010 is located lower than a proximal end PE of the first member 1010, as shown in FIG. 10D). In the configuration shown FIG. 10D, the central joint angle θ is greater than 90 degrees and H₄+L<H (herein, H₄ is an extended amount of the second elongated portion 1033, as shown in FIG. 10D). Configurations shown in FIGS. 10C and 10D may be useful for stability of the device 1000 depending on the height of a car's door striker or a condition (e.g., flatness) of the ground level G. For instance, the configuration of device 1000, as shown in FIG. 10C may be used when the door striker is located relatively close ground level G (e.g., a distance H4 from the ground level G), while the configuration of device 1000 as shown in FIG. 10D is located further away from ground level G (e.g., a distance H5 from the ground level G).

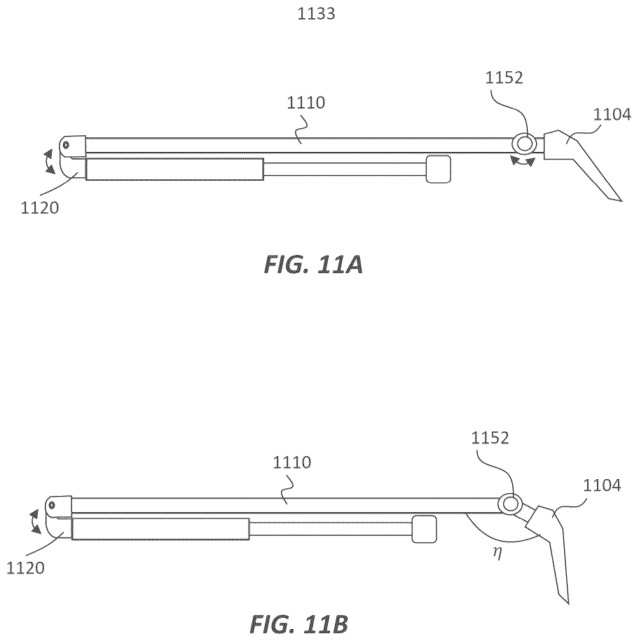

FIG. 11A shows an example embodiment of a device 1100 for providing mobility assistance, e.g., in getting in and out of a vehicle, in a folded configuration. The device 1100 may be similar to various embodiments of the previously discussed devices herein (e.g., devices 100, 200, 300, etc.) with an addition of an engagement joint 1152. The engagement joint 1152 may be configured to couple a first member 1110 of the device 1100 to the engagement portion 1104. In some cases, the engagement joint 1152 may be similar to a central joint (e.g., a central joint 1120, as shown in FIG. 11). For example, the engagement joint 1152 may be configured such that the engagement joint 1104 may be rotated relative to the first member 1110. For instance, as shown in FIG. 11B, the engagement joint 1104 is rotated relative to the first member 1110 by a user-selected engagement joint angle η. In some cases, once selected by the user, the engagement joint angle η may remain fixed (e.g., using a rachet mechanism similar to the rachet mechanism 826, as shown in FIG. 8, or using any other suitable locking mechanism, such as a locking pin, a clamp, a clip, and the like) until it is further adjusted by the user.

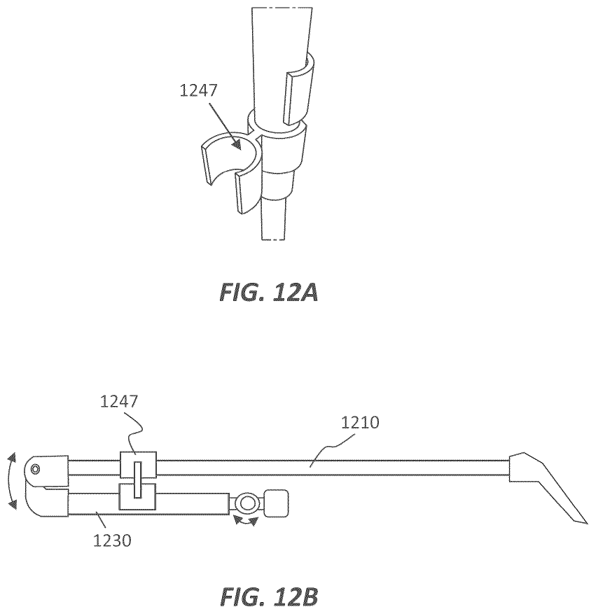

FIGS. 12A and 12B show an example device 1200 for providing mobility assistance, e.g., in getting in and out of a vehicle, according to embodiments. The device 1200 may be similar to embodiments of other devices disclosed herein (e.g., devices 100, 200, 300, etc.). The device 1200 may include a securing clip 1247 for securing a first member 1210 to the second member 1230 when the device 1200 is in the folded configuration. The securing clip 1247 is configured to maintain the first member 1210 parallel to the second member 1230 until a sufficient force is applied to separate the first member 1210 from the second member 1230 when deploying the device 1200.

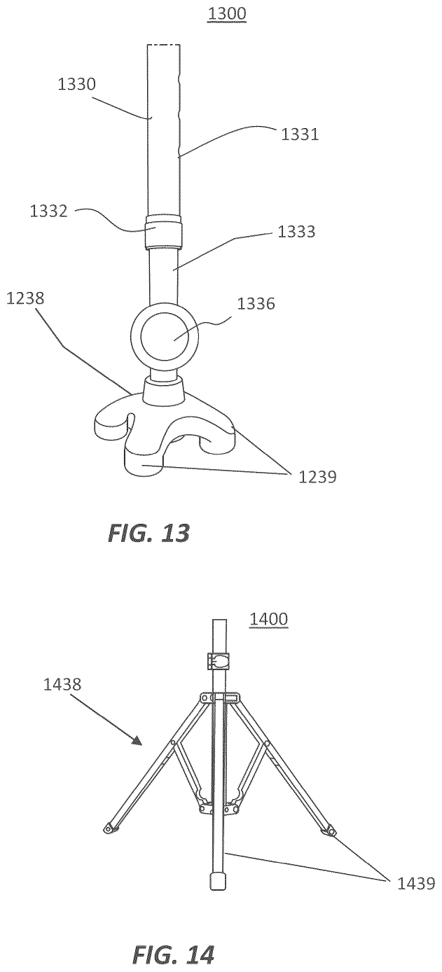

FIGS. 13-15 show example embodiments of respective devices 1300-1500 with different bases, which can provide certain advantages (e.g., improved stability, greater grip/engagement, etc.). Devices 1300-1500 can be structurally and/or functionally similar to other devices described herein (e.g., devices, 100, 200, 300, etc.). For example, FIG. 13 shows the device 1300 that includes a second member 1330 and a base 1338. In the example embodiment, the second member 1330 includes a first elongated portion 1331, a second elongated portion 1333 that can be inserted into the first elongated portion 1331, and a locking mechanism 1332 for locking the second elongated portion 1333 relative to the first elongated portion 1331 when the second elongated portion 1333 is extended from the first elongated portion 1331 by a set distance. In the example implementation, the locking mechanism 1332 is a twist lock, but as described above, other locking mechanisms can also be used. FIG. 13 shows that the base 1338 includes multiple legs 1339, which can be configured to improve support for the device 1300.

FIG. 14 shows another example embodiment of a device 1400 that includes a base 1438. The base 1438 may include multiple (three, as shown in FIG. 14) foldable legs 1439. In an example implementation, the foldable legs 1439 may be configured to be deployed (e.g., unfolded as show in FIG. 14), when the device 1400 is in a deployed configuration. Further, when the device is in a folded configuration, the foldable legs 1439 may be configured to fold, thereby reducing a profile or a space occupied by the device 1400.

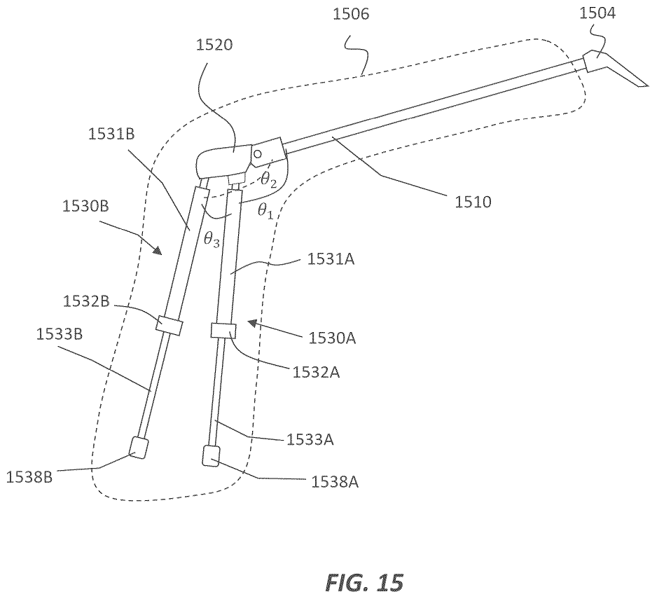

FIG. 15 shows another embodiment of a device 1500 which includes an engaging portion 1504 and an articulating leg 1506. The articulating leg includes a first member 1510 and two second members, a right second member 1530A and a left second member 1530B. In one implementation, the right second member 1530A and the left second member 1530B may include identical elements. For example, the right second member 1530A may include a right first elongated portion 1531A, a right second elongated portion 1533A, a right locking mechanism 1532A, and a right base 1538A. These elements may be similar or the same as corresponding elements of other devices described herein. Similarly, the left second member 1530B may include a left first elongated portion 1531B, a left second elongated portion 1533B, a left locking mechanism 1532B, and a left base 1538B. These elements also may be similar or the same as corresponding elements of other devices described herein. Further, the device 1500 includes a central joint 1520 configured to position the left second member 1530A and the right second member 1530B such that they form angles: θ₁—an angle between the right second member 1530A and the first member 1510, θ₂—an angle between the left second member 1530B and the first member 1510, and θ₃—an angle between the right second member 1530A and the left second member 1530B, as shown in FIG. 15. Having two second members 1530A and 1530B may improve the stability of the device 1500. Further, in some implementations when placing the device 1500 in a deployed configuration (e.g., by activating a deploying mechanism as described above), the right second member 1530A and the left second member 1530B may be positioned such that angles θ₁, θ₂, and θ₃ are selected automatically. In some cases, the device 1500 may include a suitable mechanical or electrical interface, such that a user may adjust the angles θ₂, θ₂, and θ₃ prior to using the device 1500. In some cases, the interface may allow a user to adjust one or two of the three angles θ₁, θ₂, and θ₃, while remaining angles are adjusted automatically by one or more suitable adjusting mechanisms associated with the device 1500.

Consistent with disclosed embodiments, a kit is also provided. The kit may be used to assemble a device for assisting a user in getting into and out of a vehicle. In an example embodiment, a kit may include various assembled or disassembled parts. For example, the kit may include an engagement portion configured to engage a striker in a doorframe of a vehicle and to hold the device in a fixed relationship relative to the striker. The engagement portion may be similar to or the same as the engagement portion 104 of the device 100, as shown in FIG. 1A. The kit may further include a first member of an articulating leg having a first end (herein, also referred to as a proximal end of the first member) and a second end (herein also referred to as a distal end of the first member), the first end configured to be coupled to the engagement portion. The first member may be similar to or the same as the first member 110 of the device 100. Further, the kit may include a second member of the articulating leg having a first end (herein, also referred to as a proximal end of the second member) and a second end (herein, also referred to as a distal end of the second member). The second member may be similar to or the same as the second member 130 of the device 100. Additionally, the kit may include a joint configured to pivotably connect the first member and the second member by coupling to a second end of the first member and to the first end of the second member (e.g., the joint may be referred to as a central joint and may be similar to or the same as the central joint 120 of the device 100). Additionally, the kit may include a base configured to couple to the second end of the second member (e.g., the base may be similar to or the same as the base 338, of the device 300, as shown in FIG. 3). In one embodiment, the second member of the kit may include a first elongated portion slidably connected to a second elongated portion, wherein the first elongated portion may be locked into place with respect to the second elongated portion using a second member locking mechanism so as to adjust a length of the second member. For example, the first elongated portion of the kit may be similar to or the same as the first elongated portion 531 of the second member 530, and the second elongated portion may be similar to or the same as the second elongated portion 532. Further, the second member locking mechanism may be similar to or the same as the second member locking mechanism 532. In some cases, the kit may include more than one first member, more than one second member, more than one engagement portion, more than one joint, and/or more than one base, e.g., to allow a user to selectively choose which type of member, joint, base, etc. to use, depending on need (e.g., weather conditions, ground surface angle, height of vehicle, etc.). Further, in some implementations the kit may include a base joint for coupling the base to the second end of the second member.

In some cases, various parts of the kit may be disconnected, and may be coupled to each other based on a particular need of the user. For example, if the kit contains more than one engagement portions, a particular engagement portion may be selected for assembling the device based on a type of a striker of a car for which the device is going to be used. In some cases, the kit may contain several engagement portions and/or several bases. For example, the kit may include a first base and a second base. In some case, each of the first and second bases may be configured to selectively couple to the second end of the second member. In some cases, the kit may include several types of second members. For instance, the kit may include a first type of the second member, being an extended cylindrical object, such as pipe, having a first end for coupling with the central joint and a second end for coupling with the base, and a second type of the second member which may be assembled by coupling a first elongated portion and a second elongated portion. Further, the kit may include one or more joints for coupling different parts of the device. For instance, the kit may include one or more central joints, and/or one or more base joints and/or one or more engagement joints.

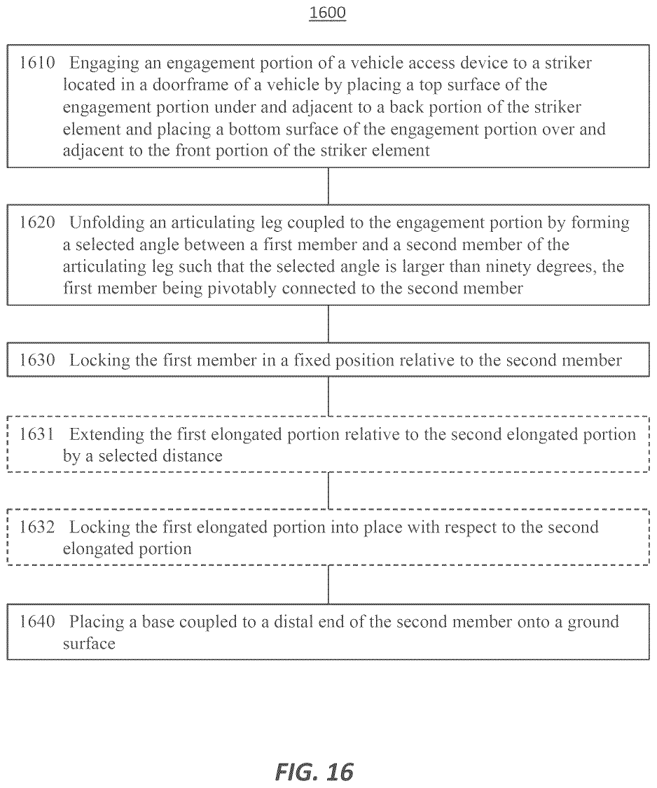

Consistent with disclosed embodiments, various methods of using a device such as any one of the vehicle access devices described herein (e.g., the device 100, 200, 300, etc.) is also provided. An example method 1600 is shown in FIG. 16 and describes placing a device, such as the device 300, into a deployed configuration. The method includes engaging an engagement portion of a vehicle access device to a striker located in a doorframe of a vehicle, e.g., by placing a top surface of the engagement portion under and adjacent to a back portion of the striker element and placing a bottom surface of the engagement portion over and adjacent to the front portion of the striker element, at 1610. Further, the method includes, at 1620, unfolding an articulating leg coupled to the engagement portion by forming a selected angle between a first member and a second member of the articulating leg such that the selected angle is larger than 90 degrees, the first member being pivotably connected to the second member. Additionally, the method 1600 includes, at 1630, locking the first member in a fixed position relative to the second member. The method 1600 includes, at 1640, placing a base coupled to a distal end of the second member onto a ground surface.

In some cases, when the second member includes a first elongated portion slidably connected to a second elongated portion, the method further includes optional 1631 of extending the first elongated portion relative to the second elongated portion by a selected distance. Additionally, the method includes, at 1632, optionally locking the first elongated portion into place with respect to the second elongated portion.

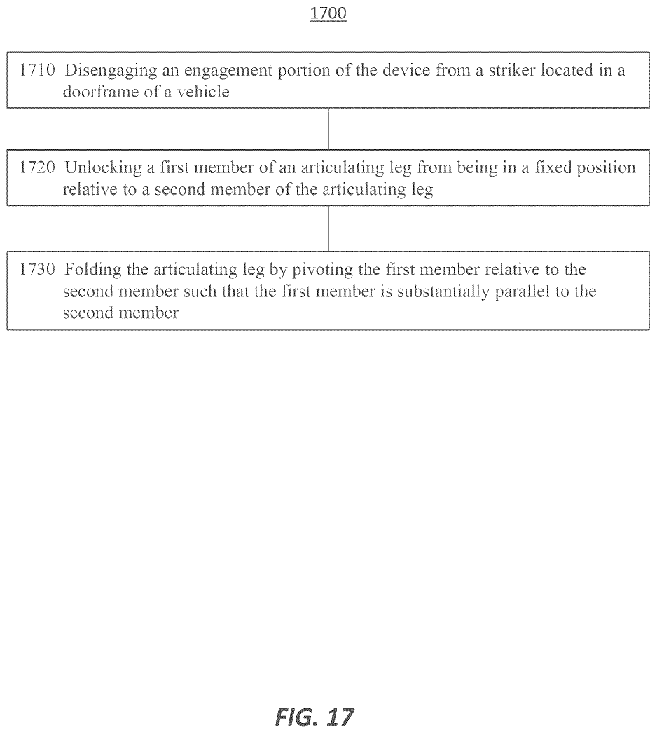

An example method 1700 is shown in FIG. 17 and describes placing a vehicle access device, such as device 300, into a folded configuration. The method 1700 includes disengaging an engagement portion of the device from a striker located in a doorframe of a vehicle, at 1710, and unlocking a first member of an articulating leg from being in a fixed position relative to a second member of the articulating leg, at 1720. The unlocking may include removing a central joint angle locking by a user actuating an unlocking mechanism. In some cases, the unlocking mechanism includes a button. At 1730, the method 1700 includes folding the articulating leg by pivoting the first member relative to the second member such that the first member is substantially parallel to the second member.

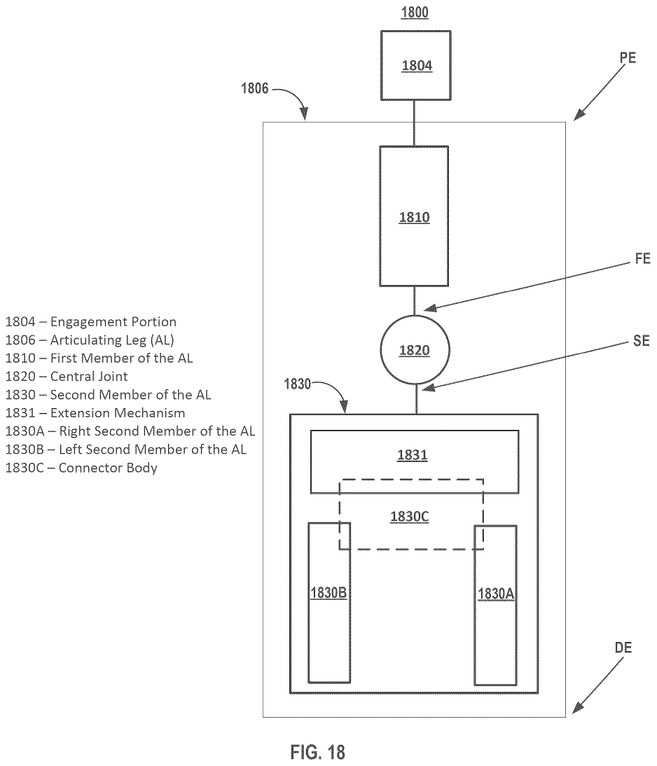

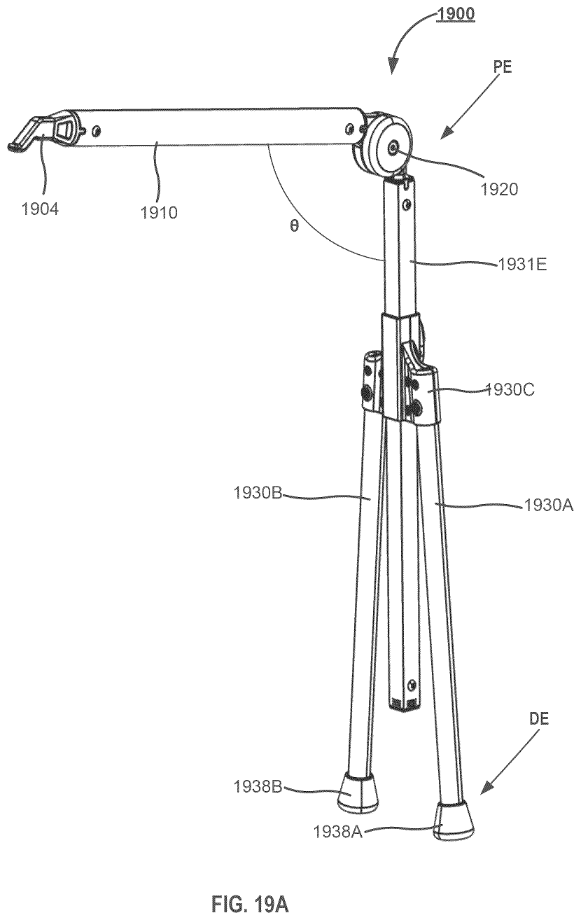

FIG. 18 illustrates an example schematic of a device 1800 for assisting a user with getting into and out of a vehicle, according to an embodiment. The device 1800 includes an engagement portion 1804 disposed at a proximal end PE and an articulating leg 1806 extending toward a distal end DE. The articulating leg 1806 includes a first member 1810, a central joint 1820, and a second member 1830. The second member 1830 comprises an extension mechanism 1831, a connector body 1830C, and two elongated members, including a right second member 1830A and a left second member 1830B, each configured to provide ground support.

The articulating leg 1806 is configured to support a user's weight when the engagement portion 1804 is engaged to a striker in a vehicle doorframe. In some embodiments, the articulating leg 1806 may support a weight in a range of about 50 lb to about 400 lb, including all values and subranges therebetween (e.g., about 100 lb to about 300 lb, about 150 lb to about 250 lb). Materials for forming the first member 1810 and second member 1830 may include metals (e.g., aluminum, steel, titanium), polymers, composites, or combinations thereof. The first member 1810 and/or the second member 1830 may have cylindrical, square, or other cross-sectional shapes (e.g., non-circular) and may be hollow, partially hollow, or solid.

In some embodiments, the engagement portion 1804 may be welded to the proximal end PE of the first member 1810, or fixedly coupled using screws, bolts, rivets, adhesives, or other suitable means. Alternatively, the engagement portion 1804 may be configured to decouple from the first member 1810 for replacement. This modularity allows selective replacement of components, such as when the engagement portion 1804 is damaged or when a different engagement portion is required to match a specific striker geometry.

The engagement portion 1804 is a rigid member configured to engage a striker in a doorframe of a vehicle and to hold the device 1800 in a fixed relationship relative to the striker. In some embodiments, the engagement portion 1804 includes a flared segment protruding outward from the rigid member, the flared segment having an indented region configured to interface with a D-ring striker plate for a snug fit.

In some embodiments, the engagement portion 1804 may include quick-release couplings, threaded interfaces, and/or universal jaws for compatibility with various striker geometries. In some embodiments, the engagement portion 1804 may include spring-loaded clips or adjustable clamps to accommodate different vehicle models. The engagement portion may also include integrated sensors to confirm proper engagement with the striker. In some embodiments, the engagement portion 1804 may include a rotatable head or pivoting interface to allow angular adjustment relative to the doorframe.

In some embodiments, the engagement portion 1084 may be formed from high-strength steel, aluminum alloys, or reinforced polymer composites. The dimensions of the engagement portion can change with respect to striker size, doorframe thickness, latch geometry, and/or the like to ensure secure engagement and load distribution. In some embodiments, a flared segment of the engagement portion 1804 can include adjustable or interchangeable inserts to accommodate striker plates having widths in a range of about 0.25 in. to about 2.5 in., including all intermediate values.

The first member 1810 extends between the engagement portion 1804 and the central joint 1820. In some embodiments, the first member 1810 is configured as a grab bar. Accordingly, in some embodiments, the first member 1810 may include a grip material disposed on at least a portion of its surface to provide a non-slip interface for the user.

In some embodiments, the first member 1810 can have a length in a range of about 16 in. to about 20 in., including all values and subranges therebetween (e.g., about 17 in. to about 19 in.). In some embodiments, the first member 1810 can have a length of 18 in. In some embodiments, the first member 1810 can have a cylindrical cross-sectional shape and can include an outer diameter in a range of about 1 in. to about 1.5 in., including all values and subranges therebetween (e.g., about 1.1 in. to about 1.4 in.). In some embodiments, the first member 1810 can alternatively have a square, rectangular, or polygonal cross-sectional shape, with a width in a range of about 0.75 in. to about 1.5 in., including all intermediate values.

In some embodiments, the first member 1810 can include telescopic adjustment for length, ergonomic contours, foam padding, or thermal insulation for comfort in extreme temperatures. In some embodiments, the first member 1810 can include integrated LED lighting for nighttime use or sensors for monitoring load distribution. In some embodiments, the first member 1810 can be operably coupled to the engagement portion 1804 via a hinge or quick-release mechanism to allow folding or removal.

In some embodiments, the central joint 1820 can allow rotation in a range of about 0° to about 120°, including all values and subranges therebetween (e.g., about 30° to about 100°), where about 0° corresponds to a folded configuration and about 120° corresponds to a deployed configuration. In some embodiments, the central joint 1820 can allow rotation in a range of about 0° to about 110°, including all values and subranges therebetween (e.g., about 30° to about 100°), where about 0° corresponds to a folded configuration and about 110° corresponds to a deployed configuration. In some embodiments, the term “open position” refers to the deployed configuration in which the articulating leg 1806 is unfolded such that the first member 1810 and the second member 1830 form an angle greater than about 90°. In some embodiments, the open position can range from about 90° to about 120°, including all intermediate values and subranges therebetween (e.g., about 95° to about 115°). In some embodiments, when the device 1800 is in the open position, the first member 1810 can be substantially parallel to a ground surface and the second member 1830 can be substantially perpendicular to the ground surface, thereby forming a stable support geometry for assisting a user in entering or exiting a vehicle. In some embodiments, the central joint 1820 can include a locking mechanism operably coupled to hinge members and configured to maintain the joint at any selected angle within the range until a threshold torque is applied to transition between positions. In some embodiments, the central joint 1820 can include a biasing assembly, such as a ball-and-spring assembly, configured to apply a spring force that urges the ball into detent recesses corresponding to discrete angular positions, such as about 0° in a closed position and about 120° in an open position, including all values and subranges therebetween (e.g., about 90° to about 110°), to maintain the articulating leg 1806 in a folded or deployed configuration until sufficient force is applied to overcome the bias.

In some embodiments, the central joint 1820 can include ratchet locking mechanisms for incremental angle adjustment, hydraulic and/or pneumatic hinges for smooth deployment, and dual-axis rotation for lateral adjustment. In some embodiments, the hinge can include a dowel pin and guide slot defining an arcuate path with detent recesses for locking the joint at selected angles. In some embodiments, the hinge can include friction pads, dampers, and/or the like to control movement speed.

The second member 1830 extends from the central joint 1820 toward the distal end DE and includes the extension mechanism 1831 and connector body 1830C. The second member 1830 includes a right second member 1830A and a left second member 1830B, each terminating at a respective base configured to contact a ground surface. In some embodiments, the second member 1830 may have a length in a range of about 14 in. to about 20 in., including all values and subranges therebetween.

In some embodiments, the second member 1830 can include foldable legs for compact storage (e.g., a tripod design) for enhanced stability, and telescopic adjustment for independent height control. In some embodiments, the second member 1830 can include integrated shock absorbers or vibration dampers for uneven terrain.

In some embodiments, the second member 1830 can include foldable legs for compact storage and enhanced stability. For example, in some embodiments, the second member 1830 can include a tripod design in which three legs extend radially from a central hub operably coupled to the connector body 1830C or directly to the extension mechanism 1831 when the connector body is absent. In some embodiments, the tripod legs can be pivotably coupled to the hub and configured to rotate between a folded position, in which the legs are disposed substantially parallel to the second member 1830, and a deployed position, in which the legs extend outward at an angle to provide a wide base of support. In some embodiments, each leg can include a locking mechanism configured to maintain the leg in the deployed position until a release force is applied. In some embodiments, the legs can include telescopic segments configured to adjust length independently, allowing the device 1800 to maintain stability on uneven terrain. In some embodiments, the tripod legs can terminate in bases including anti-slip pads, suction cups, and/or the like for enhanced traction on various surfaces. In some embodiments, when the connector body 1830C is absent, the tripod hub can be directly operably coupled to an elongated portion of the extension mechanism 1831, thereby reducing overall weight and/or simplifying assembly while maintaining stability.

In some embodiments, the extension mechanism 1831 is operably coupled to the central joint 1820 and to the right and left second members 1830A, 1830B. In some embodiments, the extension mechanism 1831 can include an elongated portion. In some embodiments, the elongated portion can be a tubular member having a non-circular cross section. In some embodiments, the elongated portion can be a tubular member with a square cross-sectional shape to prevent rotation. In some embodiments, the elongated portion can alternatively have a circular, rectangular, or polygonal cross-sectional shape, including all variations of dimensions. In some embodiments, the elongated portion can be formed as a solid rod rather than a hollow tube. In some embodiments, the elongated portion can include a composite structure with internal reinforcement ribs or honeycomb patterns for strength while minimizing weight. In some embodiments, the elongated portion can be made from metal (e.g., aluminum, steel), polymer, or fiber-reinforced composite materials. In some embodiments, the elongated portion may have a plurality of apertures disposed longitudinally along its length. In some embodiments, the elongated portion can further include surface features such as grooves, splines, or keyways to prevent rotation and ensure alignment with the connector body 1830C or directly with the second members 1830A, 1830B when the connector body is absent.

In some embodiments, the extension mechanism 1831 can further include a locking mechanism configured to engage with the apertures to secure the elongated portion at a selected position. In some embodiments, the elongated portion can be configured to increase the overall length of the device 1800 relative to a ground surface, thereby adjusting the vertical distance between the central joint 1820 and the bases of the second members 1830A, 1830B. In some embodiments, the extension range can be in a range of about 22 in. to about 42 in., including all values and subranges therebetween (e.g., about 24 in. to about 36 in., about 28 in. to about 40 in.). In some embodiments, the extension mechanism 1831 can allow the device 1800 to accommodate vehicles having striker heights in a range of about 18 in. to about 36 in., including all intermediate values, by selectively increasing or decreasing the length of the elongated portion. In some embodiments, the elongated portion can be telescopic and can include two or more nested segments configured to slide relative to each other.

In some embodiments, the extension mechanism 1831 can include a release pin mechanism operably coupled to a button accessible through an external surface of the connector body 1830C, the button configured to actuate the release pin mechanism to selectively lock or release the elongated portion. In some embodiments, the extension mechanism 1831 can include alternative configurations such as ratcheting locks, hydraulic cylinders, or motorized actuators for automatic adjustment. The extension mechanism 1831 may also include a combination system for rough and/or fine adjustment.

In some embodiments, the connector body 1830C can include a first portion and a second portion coupled together to define an inner cavity configured to receive the elongated portion of the extension mechanism 1831 and the right and left second members 1830A, 1830B. In some embodiments, the connector body 1830C can include a first end with a first protruding shoulder configured to engage with the right second member 1830A and a second end with a second protruding shoulder configured to engage with the left second member 1830B. In some embodiments, the connector body 1830C can include integrated bushings or bearings within the inner cavity to facilitate smooth sliding of the elongated portion and reduce friction during adjustment. In some embodiments, the connector body 1830C can include removable covers or panels to allow access for maintenance or replacement of internal components. In some embodiments, the connector body 1830C can include modular segments configured to be detached and replaced individually, thereby enabling quick customization or repair. In some embodiments, the connector body 1830C can include integrated shock absorbers or vibration dampers to improve stability when the device 1800 is used on uneven terrain.

In some embodiments, the connector body 1830C can be optional, and the extension mechanism 1831 can couple directly to the second members 1830A, 1830B via pivot joints, sliding collars, or clamping brackets. In some embodiments, omitting the connector body 1830C can reduce overall weight and simplify assembly while maintaining operable coupling between the extension mechanism 1831 and the second members 1830A, 1830B.

In some embodiments, the second members 1830A and 1830B can each include a length in a range of about 10 in. to about 20 in., including all values and subranges therebetween (e.g., about 13 in. to about 19 in.). In some embodiments, these lengths can be selected to provide sufficient ground contact and stability when the device 1800 is in a deployed configuration. In some embodiments, the length of each second member can vary based on the extension of the elongated portion of the extension mechanism 1831, such that increasing the extension length adjusts the overall height of the device relative to the ground surface. In some embodiments, the second members 1830A, 1830B can be operably coupled to the connector body 1830C or, when the connector body is omitted, directly to the elongated portion of the extension mechanism 1831 via pivot joints or sliding collars. In some embodiments, the second members can include telescopic segments configured to allow independent adjustment of length for uneven terrain. In some embodiments, the distal ends of the second members can include bases with anti-slip pads, suction cups, or magnetic feet to enhance traction. In some embodiments, the second members can include integrated shock absorbers or vibration dampers to improve stability during use.

In operation, the engagement portion 1804 is inserted into a striker, and the articulating leg 1806 is deployed such that the first member 1810 forms an angle with the second member 1830. The extension mechanism 1831 adjusts the height of the second member to ensure stable ground contact. In some embodiments, the device 1800 may include sensors to detect proper engagement and deployment, audible alerts for incorrect positioning, and overload protection to prevent structural failure.

In some embodiments, the device 1800 can function as a walking aid when detached from the striker and may include electronic features such as LED lights for nighttime use. The device 1800 can be compatible with accessories such as storage pouches or cup holders, which may attach via clips or straps. For outdoor durability, the device 1800 may include corrosion-resistant coatings and weather-resistant materials. Portability may be achieved through a hinge-based quick-fold mechanism that enables the user to apply manual force to open or close the device without tools, allowing compact storage and transport. In some embodiments, the hinge can include a locking feature to secure the device in either the folded or extended position. Alternatively, the device may incorporate a fold or deployment mechanism utilizing a push-button torque release and safety locks to provide quick folding and enhanced portability.

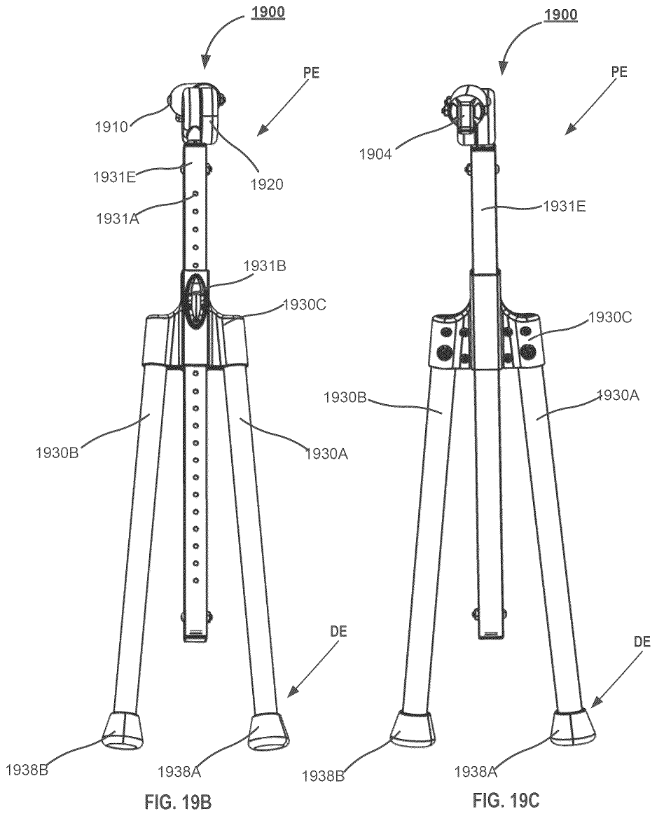

FIG. 19A illustrates a side view of an exemplary device 1900, according to an embodiment. The device 1900 includes an engagement portion 1904 disposed at a proximal end PE, configured to engage a striker in a vehicle doorframe. Extending from the engagement portion 1904 is an elongated member 1910, which may function as a grab bar and can include grip features (e.g., ergonomic grip features) similar to those described for device 1800 in FIG. 18. In some embodiments, the elongated member 1910 can be the same as or similar to the first member 1810 of the articulating leg of device 1800.

The elongated member 1910 is operably coupled to a hinge assembly 1920, which connects to a vertical support 1931E. The hinge assembly 1920 is configured to allow rotation of the elongated member 1910 relative to the vertical support, forming an angle θ that may range from about 0° in a folded configuration to about 120° in a deployed configuration, including all intermediate values (e.g., about 90° to about 110°). In some embodiments, the hinge assembly 1920 can be the same as or similar to the central joint 1820 of device 1800. The hinge assembly 1920 may include a bi-stable mechanism or detent-based locking system, such as a ball-and-spring assembly or a dowel pin and arcuate guide slot, configured to maintain the device in either an open or closed position until sufficient force is applied.

The distal end DE includes two support legs 1930A and 1930B coupled to a connector body 1930C. In some embodiments, the support legs 1930A and 1930B can be the same as or similar to the right second member 1830A and the left second member 1830B of the articulating leg of device 1800, respectively. Each support leg terminates in a respective base 1938A or 1938B. In some embodiments, the bases 1938A and 1938B can be the same as or similar to the bases described for device 1800. The bases may include anti-slip pads, suction cups, or other traction-enhancing features to improve stability on various surfaces.

FIG. 19B illustrates a front view of the device 1900 in an extended configuration. The elongated member 1910 is aligned along a central axis above the vertical support 1931E, which includes a plurality of apertures 1931A disposed longitudinally along its length. A button 1931B is operably coupled to a release pin mechanism configured to engage one of the apertures to lock the vertical support at a selected height. In some embodiments, the vertical support 1931E can be the same as or similar to the extension mechanism 1831 of device 1800. This arrangement allows the overall length of the device to be adjusted to accommodate different vehicle striker heights, for example, in a range of about 22 inches to about 42 inches. The support legs 1930A and 1930B diverge from the central axis to provide a stable base and are coupled to the connector body 1930C, which may include integrated bushings or bearings to facilitate smooth adjustment.

FIG. 19C illustrates a rear view of the device 1900, showing the opposite side of the hinge assembly 1920 and engagement portion 1904. The rear view highlights the attachment points between the vertical support 1931E and the connector body 1930C, as well as the coupling of the support legs 1930A and 1930B. The bases 1938A and 1938B are shown from the rear perspective, demonstrating their orientation relative to the legs. In some embodiments, the connector body 1930C can be the same as or similar to the connector body 1830C of device 1800. The hinge assembly 1920 may further include friction pads or dampers to control movement speed and optional dual-axis rotation for lateral adjustment.

In operation, the engagement portion 1904 may be configured to engage a striker in a vehicle doorframe, similar to engagement portion 1804 described with respect to FIG. 18. When deployed, the elongated member 1910 may be substantially horizontal, and the vertical support 1931E may be substantially vertical, forming a stable geometry for supporting a user's weight.

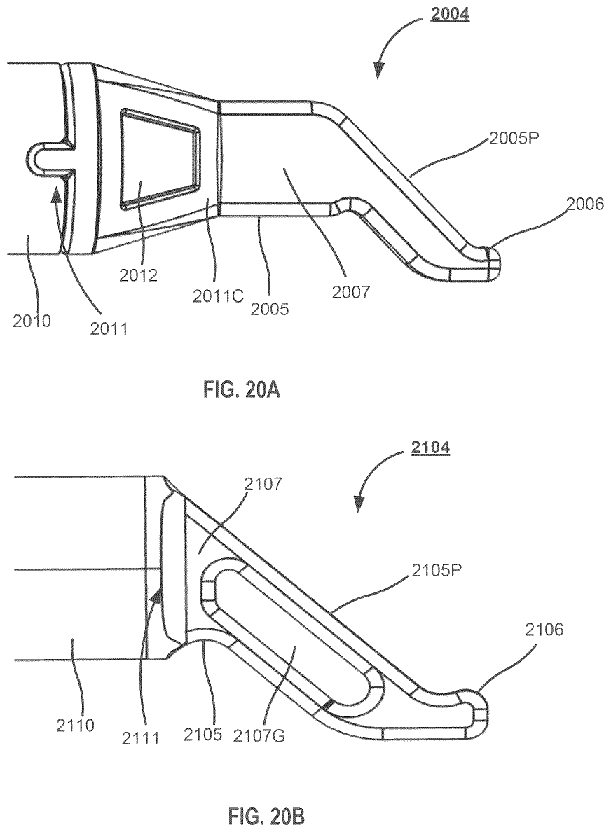

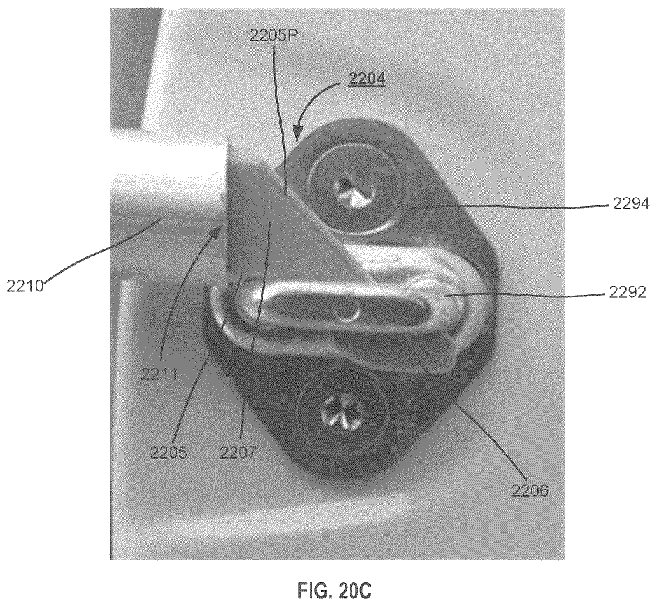

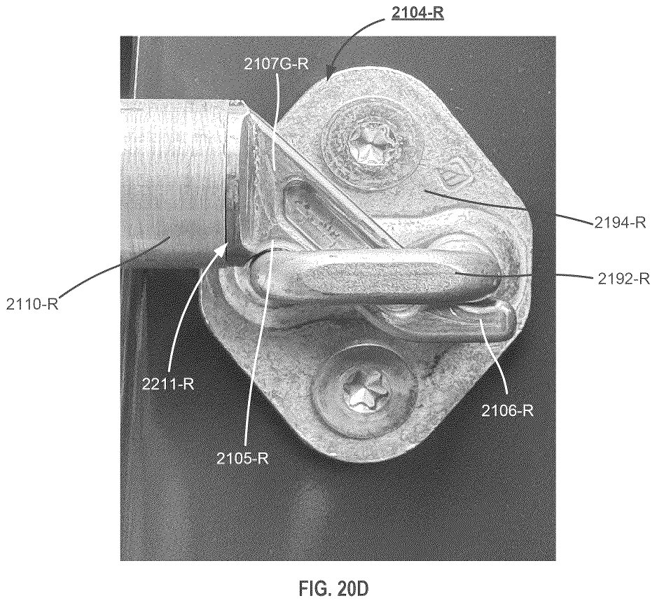

FIG. 20A illustrates a side view of an engagement portion 2004, according to an embodiment. The engagement portion 2004 is configured to be coupled to a first member 2010 through a connector segment 2011C. The connector segment 2011C includes a coupling interface 2011, which defines the region for attachment to the first member 2010. In some embodiments, the coupling interface 2011 may include a threaded joint, a quick-release pin, a welded interface, and/or other mechanical connectors to provide secure and rigid attachment.

In some embodiments, a groove 2012 can be disposed on a portion of a side surface of the connector segment 2011C. The groove 2012 may serve as an alignment and/or relief feature during assembly. Extending distally from the connector segment 2011C is a body 2007 of the engagement portion. The body 2007 includes a bottom portion 2005 and a protruding segment 2006. The bottom portion 2005 projects outward and downward relative to the longitudinal axis of the connector segment 2011C and includes a bearing surface 2005P, which is substantially flat and positioned at an angle to provide a stable contact area when the engagement portion 2004 is inserted into a striker. Distal to the bottom portion 2005, the protruding segment 2006 curves upward and terminates at a distal end configured to engage behind a striker bar. The contoured geometry of the body 2007, including the transition between the bottom portion and the protruding segment, may facilitate insertion and locking within the striker opening.

FIG. 20B illustrates a side view of an engagement portion 2104, according to an embodiment. The engagement portion 2104 is configured to couple to a first member 2110 through a coupling interface 2111 located at its proximal end. The coupling interface 2111 may include features for mechanical fastening, quick-release attachment, or may be formed monolithically with the first member 2110. Extending distally from the coupling interface is a body 2107 of the engagement portion 2004. The body 2107 includes a bottom portion 2105 having a bearing surface 2105P oriented along an inclined plane relative to the coupling interface 2111. The bearing surface 2105P is positioned to provide a stable contact area when the engagement portion is seated against a striker.

Formed within the body 2107 is a longitudinal groove 2107G, which extends along the bottom portion 2105. The groove 2107G may serve as a weight-reduction feature while maintaining structural integrity and may also provide clearance or alignment during assembly. Distal to the bottom portion 2105, a protruding segment 2106 extends forward and terminates at a distal tip configured to engage a striker opening. The geometry of the body 2107, including the transition between the bottom portion and the protruding segment, defines a continuous angled profile that facilitates insertion and secure seating within the striker.

FIG. 20C illustrates an engagement portion 2204 in an engaged position with a striker 2292 mounted on a base plate 2294, according to an embodiment. The engagement portion 2204 includes a body 2207 having a bottom portion 2205 and a protruding segment 2206. The bottom portion 2205 includes a bearing surface 2205P that extends over and rests against the upper surface of the striker bar of striker 2292, providing a stable contact area that resists upward displacement. The protruding segment 2206 extends downward and forward beneath the striker bar, creating a mechanical interlock that resists withdrawal under load. The engagement portion 2204 is coupled to a first member 2210 via a connector interface 2211, which may include a threaded joint, welded interface, quick-release coupling, or may be formed monolithically with the first member. In operation, the engagement portion 2204 can be inserted by a user into the striker opening at an angle and then rotated or pivoted slightly so that the bottom portion 2205 seats over the striker 2292 while the protruding segment 2206 engages beneath it. When fully engaged, the bearing surface 2205P contacts the striker base plate 2294, and the protruding segment 2206 locks under the striker 2292.

FIG. 20D illustrates an engagement portion 2104-R in an engaged position with a striker 2192-R mounted on a base plate 2194-R, according to an embodiment. The engagement portion 2104-R is configured to couple to a first member 2110-R through a coupling interface 2111-R located at its proximal end. The coupling interface 2111-R may include features for mechanical fastening, quick-release attachment, or may be formed monolithically with the first member 2110-R. Extending distally from the coupling interface is a body 2107-R of the engagement portion 2004-R. The body 2107-R includes a bottom portion 2105-R having a bearing surface 2105P-R oriented along an inclined plane relative to the coupling interface 2111-R. The bearing surface 2105P-R is positioned to provide a stable contact area when the engagement portion is seated against a striker.

Formed within the body 2107-R is a longitudinal groove 2107G-R, which extends along the bottom portion 2105-R. The groove 2107G-R may serve as a weight-reduction feature while maintaining structural integrity and may also provide clearance or alignment during assembly. Distal to the bottom portion 2105-R, a protruding segment 2106-R extends forward and terminates at a distal tip configured to engage a striker opening. The geometry of the body 2107-R, including the transition between the bottom portion and the protruding segment, defines a continuous angled profile that facilitates insertion and secure seating within the striker 2192-R.

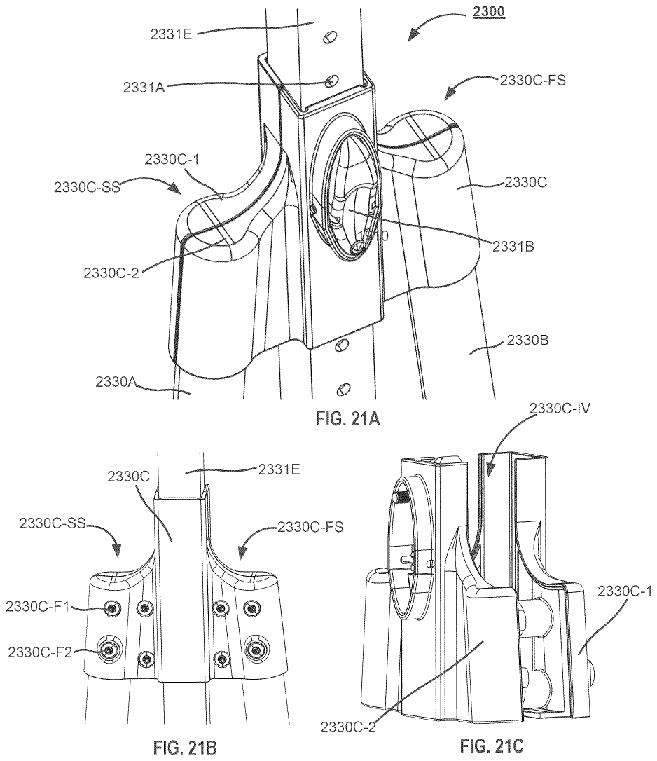

FIG. 21A illustrates a side view of the connector body 2330C operably coupled to the vertical support 2331E and support legs 2330A and 2330B. The vertical support 2331E includes apertures 2331A and a button 2331B configured to actuate a release pin mechanism for height adjustment. The connector body 2330C includes a first shoulder 2330C-FS configured to receive the proximal end of the first support leg 2330A and a second shoulder 2330C-SS configured to receive the proximal end of the second support leg 2330B. In some embodiments, these shoulders may include cylindrical bores or keyed recesses to prevent rotation and ensure secure coupling. The connector body further defines an internal volume 2330C-IV configured to receive at least a portion of the vertical support 2331E and at least a portion of each support leg 2330A, 2330B. This internal volume may include guide surfaces, splines, or locking features to maintain alignment and prevent torsional movement during use.

FIG. 21B illustrates a rear view of the connector body 2330C, showing the first portion 2330C-1 and second portion 2330C-2 joined together. In some embodiments, the first and second portions can be secured using fasteners such as bolts, screws, and/or rivets. FIG. 21B shows connectors 2330C-F1 and 2330C-F2, which may correspond to threaded inserts or through-holes for bolts. Connector 2330C-F2 is shown protruding outward, which indicates a design for accommodating a locking pin or alignment dowel that extends beyond the outer surface to engage with an external bracket or accessory. In some embodiments, the protrusion of 2330C-F2 can provide a mechanical stop or serve as a mounting point for additional components. The fastening mechanism may include torque-controlled bolts passing through aligned apertures in the first portion 2330C-1 and second portion 2330C-2, optionally with washers or bushings to distribute load and prevent loosening under vibration.

FIG. 21C illustrates an exploded view of the connector body 2330C without the remaining device components, showing the internal volume 2330C-IV and the relative positioning of the first portion 2330C-1 and second portion 2330C-2. In some embodiments, the internal volume may include ribs or splines to prevent rotation of the vertical support 2331E. The first portion 2330C-1 and second portion 2330C-2 may be joined along a mating interface using mechanical fasteners, adhesive bonding, or a combination thereof. The shoulders 2330C-FS and 2330C-SS may include integrated bushings or bearings to facilitate smooth insertion of the support legs 2330A and 2330B, and locking pins or set screws may be used to secure the legs in position. In some embodiments, the connector body 2330C may be formed from high-strength polymer or metal alloys and may include corrosion-resistant coatings for outdoor durability.

In operation, the connector body 2330C can provide structural reinforcement and/or alignment between the vertical support 2331E and the support legs 2330A, 2330B, enabling the device 2300 to maintain stability under load. In some embodiments, the multi-part construction of the connector body 2330C can allow for modular assembly and maintenance.

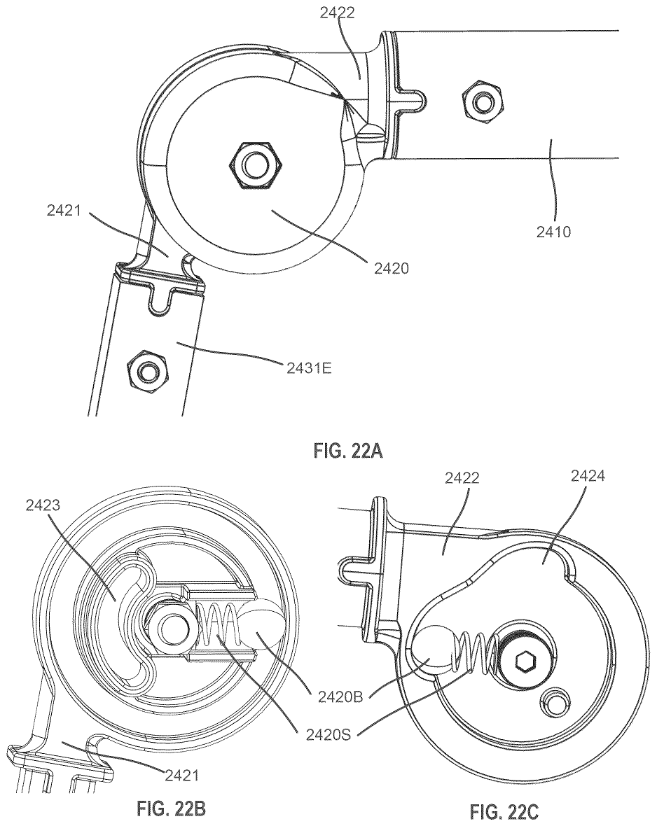

FIG. 22A illustrates a side view of a hinge assembly 2420 operably coupled between a first member 2410 and a vertical support 2431E, according to an embodiment. The hinge assembly 2420 is configured to allow rotation of the first member 2410 relative to the vertical support 2431E between a closed position and an open position. The hinge assembly 2420 includes a first hinge portion 2421 and a second hinge portion 2422, which together form an internal cavity housing a bi-stable mechanism. The first hinge portion 2421 is disposed into and secured to the first member 2410, while the second hinge portion 2422 is disposed into and secured to the vertical support 2431E. Each hinge portion can include a mounting interface configured to receive fasteners for rigid attachment to the respective structural members.

In some embodiments, the first hinge portion 2421 can be coupled to the second hinge portion 2422 by a central fastening assembly that passes through coaxially aligned apertures formed in both hinge portions. The coupling creates a pivot axis that enables controlled rotation between the first member 2410 and the vertical support 2431E. The hinge portions 2421, 2422 may include complementary mating surfaces configured to nest together, thereby maintaining alignment and distributing load across the interface. In some embodiments, the coupling can include a bolt and nut assembly, a shoulder screw, or a dowel pin disposed within the aligned apertures. Washers or bushings can be positioned between the hinge portions to reduce friction and wear during rotation. In other embodiments, the hinge portions 2421, 2422 can include interlocking flanges or keyed recesses that prevent lateral displacement and ensure alignment during operation. The fastening assembly can be tightened to provide adjustable clamping force, allowing the hinge to maintain a desired level of rotational resistance while still permitting movement when sufficient torque is applied.

FIG. 22B illustrates an exploded side view of the hinge assembly 2420, showing internal components of the bi-stable mechanism. The bi-stable mechanism includes a ball 2420B and a spring 2420S disposed within the internal cavity. The spring 2420S applies a biasing force to the ball 2420B, urging the ball into engagement with detent recesses formed along an arcuate track 2423. The arcuate track 2423 is defined within the hinge assembly and dictates the angular range of rotation between the first member 2410 and the vertical support 2431E. In some embodiments, the arcuate track 2423 allows rotation between about 0 degrees in the closed position and about 100 degrees in the open position. In other embodiments, the open position can range from about 90 degrees to about 120 degrees, e.g., with a range of about 100 degrees to about 110 degrees, for stability and user clearance.

FIG. 22C illustrates an exploded side view of the hinge assembly 2420, showing internal components of the bi-stable mechanism. The ball 2420B is configured to snap into detent recesses corresponding to discrete angular positions, such as the closed position and the open position, thereby maintaining the hinge assembly in either position until sufficient torque is applied to overcome the spring force. This bi-stable configuration ensures that the articulating leg remains securely locked in the folded configuration during storage and in the deployed configuration during use.

In some embodiments, the hinge assembly 2420 can include a guide slot 2424 formed in the second hinge portion 2422. The guide slot 2424 receives a pin operably coupled to the first hinge portion 2421, and the interaction between the pin and the guide slot dictates the angular path of rotation. The guide slot 2424 can include detent recesses aligned with the arcuate track to provide redundant locking at selected angular positions. In some embodiments, the hinge assembly can further include friction pads or dampers disposed within the internal cavity to control movement speed and prevent abrupt transitions between positions. In other embodiments, the hinge assembly can include a secondary locking mechanism, such as a latch or clamp, to provide additional security when the device is deployed.

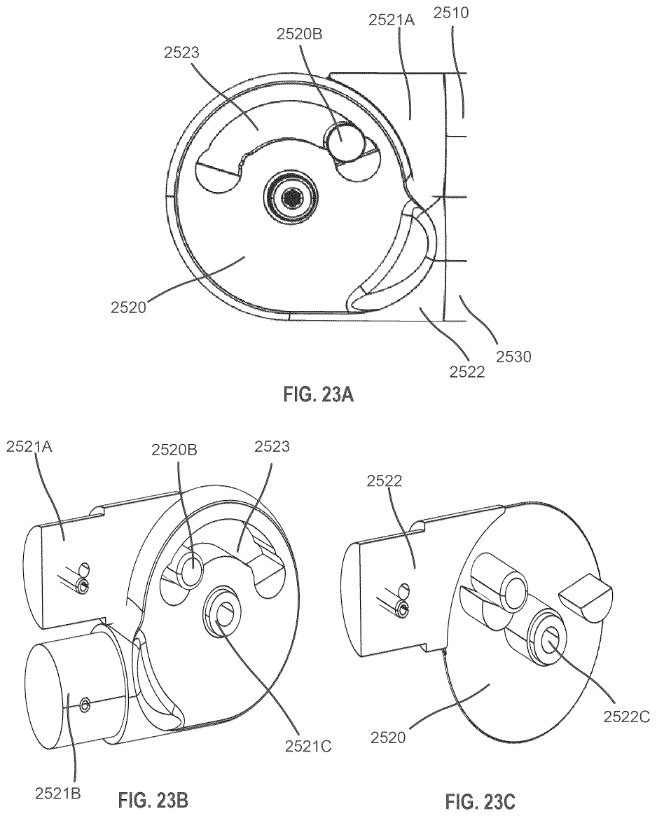

FIG. 23A illustrates a side view of a hinge assembly 2520 in a folded or closed position, according to an embodiment. The hinge assembly 2520 pivotably couples a first member 2510 to a second member 2530, enabling rotation between a closed position and an open position. The hinge assembly includes a first hinge portion 2521 and a second hinge portion 2522, which together define a hinge mechanism configured for controlled rotation and positional locking.

In some embodiments, the first hinge portion 2521 can include a first interface 2521A disposed into or secured within the first member 2510, and a second interface 2521B configured to engage the second member 2530. Similarly, the second hinge portion 2522 can include a coupling interface 2522C configured to mate with the first hinge portion 2521 along a complementary surface. The hinge portions can be joined by a central fastening assembly extending through coaxially aligned apertures formed in both hinge portions. This fastening assembly defines the pivot axis of the hinge and maintains structural integrity during rotation. In some embodiments, the fastening assembly can include a dowel pin combined with washers or bushings to reduce friction and wear.

FIG. 23B illustrates an exploded perspective view of the hinge assembly 2520, showing the dowel pin and guide system. The hinge includes a dowel pin 2520B disposed within a guide slot 2523 formed in one of the hinge portions. The interaction between the dowel pin 2520B and the guide 2523 slot dictates the angular path of rotation and provides positional control. The guide slot includes detent recesses corresponding to discrete angular positions, such as the closed position and the open position. When the hinge rotates, the dowel pin 2520B travels along the guide slot 2523 and snaps into the detent recesses, maintaining the hinge in either position until sufficient torque is applied to overcome the detent resistance.

FIG. 23C illustrates a perspective view of the second hinge portion 2522, showing the coupling features and guide slot. Unlike the bi-stable mechanism described in FIGS. 22A-22C, this hinge option does not rely on a spring-biased ball. Instead, the user applies force to move the dowel pin 2520B out of a detent recess and into the next position. The detents allow the hinge to lock in the opened or closed position and unlock when enough force is applied.

In some embodiments, the hinge assembly 2520 can allow rotation between about 0 degrees in the closed position and about 100 degrees in the open position. In other embodiments, the open position can range from about 90 degrees to about 120 degrees, with an optimal range of about 100 degrees to about 110 degrees for stability and user clearance.

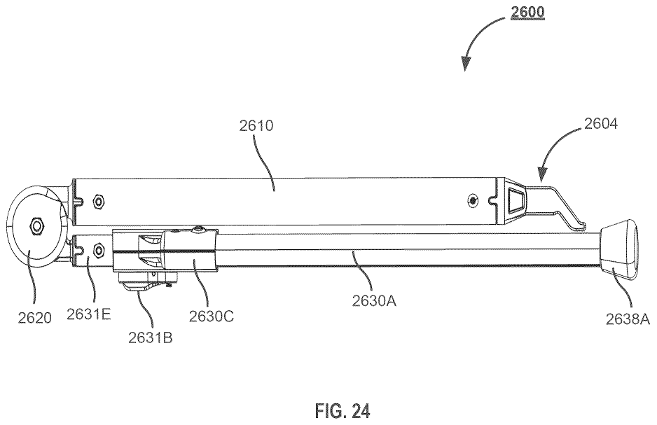

FIG. 24 illustrates a side view of an exemplary device 2600 in a folded configuration, according to an embodiment. The device 2600 may be the same as or similar to the devices described with respect to FIGS. 18, 19A-19C (e.g., device 1800, 1900). The device 2600 includes an engagement portion 2604 disposed at a proximal end, configured to engage a striker in a vehicle doorframe. Extending from the engagement portion 2604 is an elongated member 2610, which may function as a grab bar and can include ergonomic grip features similar to those described for device 1900. The elongated member 2610 is operably coupled to a hinge assembly 2620, which connects to a vertical support 2631E. The hinge assembly 2620 is configured to allow rotation of the elongated member 2610 relative to the vertical support between a folded configuration (as shown) and a deployed configuration, forming an angle that may range from about 0° to about 120° (e.g., from about 0° to about 110°), inclusive all values. The hinge assembly 2620 may include a bi-stable mechanism or detent-based locking system, such as a ball-and-spring assembly or dowel pin and arcuate guide slot, configured to maintain the device in either an open or closed position until sufficient force is applied. The vertical support 2631E includes a plurality of apertures (not shown) disposed longitudinally along its length and a button 2631B operably coupled to a release pin mechanism configured to engage one of the apertures to lock the vertical support at a selected height. Coupled to the vertical support 2631E is a connector body 2630C, which joins a support leg 2630A terminating in a base 2638A. The base 2638A may include anti-slip pads, suction cups, or other traction-enhancing features to improve stability on various surfaces. In the folded configuration shown, the elongated member 2610 and vertical support 2631E are aligned for compact storage, while the engagement portion 2604 remains accessible for quick deployment.

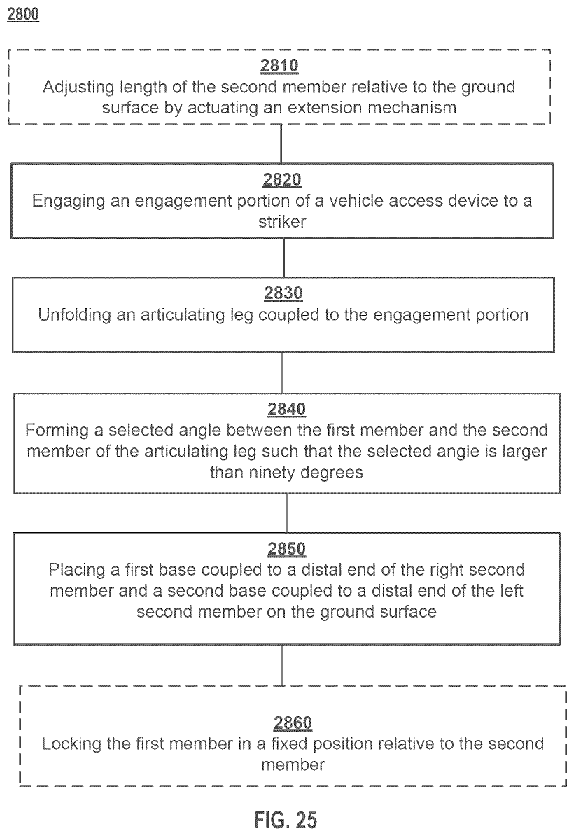

FIG. 25 illustrates a block diagram of a method 2800 for deploying a vehicle access device, according to an embodiment. Method 2800 can be implemented using any of the vehicle access devices described herein with respect to FIGS. 18 and 19. In some embodiments, the method 2800 is performed using a device that includes an engagement portion configured to engage a striker in a vehicle doorframe and an articulating leg operably coupled to the engagement portion. The articulating leg can include a first member and a second member pivotably connected at a central joint, the second member comprising a right second member and a left second member, each terminating in a base configured to contact a ground surface. In some embodiments, the device can further include an extension mechanism operably coupled to the second member to adjust its length relative to the ground surface. In other embodiments, the device can include a connector body defining an inner cavity configured to receive an elongated portion and the right and left second members, the connector body operable to slidably connect the elongated portion to the second members. In some embodiments, the engagement portion can include a rigid member having a proximal flared segment configured to interface with a D-ring striker plate, and in other embodiments, the engagement portion can include adjustable jaws, spring-loaded clips, or threaded couplings to accommodate different striker geometries. In some embodiments, the central joint can include a locking mechanism configured to maintain a selected angle between the first and second members, and in other embodiments, the bases can include anti-slip pads, suction cups, or pivot joints to maintain flat contact on uneven terrain.

The method 2800 includes engaging an engagement portion of a vehicle access device to a striker located in a doorframe of a vehicle, at 2820, unfolding an articulating leg coupled to the engagement portion, at 2830, the articulating leg including a first member and a second member pivotably connected to each other, the second member including a right second member and a left second member, each configured to be placed onto a ground surface, and forming a selected angle between the first member and the second member of the articulating leg such that the selected angle is larger than ninety degrees, at 2840. The method 2800 further includes a first base coupled to a distal end of the right second member and a second base coupled to a distal end of the left second member on the ground surface to support the vehicle access device, at 2850. Optionally, the method 2800 can include adjusting length of the second member relative to the ground surface by actuating an extension mechanism, at 2810, and locking the first member in a fixed position relative to the second member, at 2860.

At 2810, in some embodiments, adjusting the length of the second member relative to the ground surface can include using an extension mechanism configured to selectively increase or decrease the overall height of the articulating leg. The extension mechanism may include an elongated portion that is slidably received within a connector body defining an inner cavity. In some embodiments, the elongated portion can include a plurality of apertures disposed longitudinally along its length, and the connector body can include a locking mechanism configured to engage one of the apertures to secure the elongated portion at a selected position.

In other embodiments, the extension mechanism can include telescopic segments configured to nest within each other for compact storage and smooth extension. In some embodiments, the extension mechanism can include a ratcheting lock system configured to provide incremental adjustment. In some embodiments, the extension mechanism can include a motorized actuator configured to automatically extend or retract the second member in response to user input, such as pressing a button or activating an electronic control.

Locking the elongated portion can be achieved in some embodiments by actuating a release pin mechanism disposed within the inner cavity of the connector body. The release pin mechanism can be operably coupled to a button accessible through an external surface of the connector body, and pressing the button can selectively lock or release the elongated portion. In some embodiments, the release pin mechanism can include a spring-biased pin configured to engage a locking recess or detent formed along the elongated portion. In some embodiments, hydraulic or pneumatic locking systems can be used to provide smooth and secure adjustment.

At 2820, in some embodiments, engaging the engagement portion can include inserting an engagement portion that includes a rigid member such that the rigid member is positioned to interface with the striker and resist displacement under load. In some embodiments, the rigid member can include a proximal flared segment configured to extend beneath the striker so that an indented region of the flared segment receives and supports a lower portion of the striker. The flared segment may protrude outward from the rigid member and be shaped to interface with a D-ring striker plate for secure engagement.

In some embodiments, the engagement portion can be formed monolithically with the first member of the articulating leg. In other embodiments, the engagement portion can be coupled to the first member via a quick-release interface, such as a latch or pin-based mechanism, allowing rapid attachment and detachment for portability or replacement.

In some embodiments, the engagement portion can include adjustable jaws configured to clamp onto the striker, providing compatibility with strikers of varying dimensions. In other embodiments, the engagement portion can include spring-loaded clips that automatically lock onto the striker upon insertion, reducing the need for manual adjustments. In some embodiments, threaded couplings can be used to secure the engagement portion to the striker, providing a rigid and vibration-resistant connection suitable for heavy loads.

In some embodiments, the engagement portion can include interchangeable inserts or modular adapters to accommodate different striker geometries. In other embodiments, the engagement portion can include pivot joints or rotatable heads to allow angular adjustment relative to the doorframe for improved ergonomics and user comfort.

In some embodiments, at 2830, unfolding can include rotating the first member relative to the second member until a selected angle is achieved. In some embodiments, unfolding can be manual or assisted by a spring-based or motorized mechanism. In other embodiments, the central joint can include a ratchet or detent system for incremental angle adjustment.

At 2830, unfolding an articulating leg coupled to the engagement portion can include unfolding an articulating leg that is operably coupled to the engagement portion to transition the vehicle access device from a compact configuration to a deployed configuration. This operation positions the first member and second member at an angle suitable for supporting a user during entry or exit from a vehicle.

In some embodiments, unfolding can include rotating the first member relative to the second member about a central joint until a selected angle is achieved. The rotation may occur within a plane substantially perpendicular to the ground surface to maintain stability. In some embodiments, the unfolding process can be performed manually by the user applying force to pivot the first member relative to the second member. In other embodiments, unfolding can be assisted by a spring-based mechanism configured to bias the articulating leg toward an open position, reducing the effort required by the user. In yet other embodiments, unfolding can be powered by a motorized actuator operably coupled to the central joint, enabling automated deployment upon activation of a control switch or button.

In some embodiments, the central joint can include a ratchet mechanism configured to allow incremental angular adjustment and maintain the selected angle. In other embodiments, the central joint can include a detent system including a series of recesses and a spring-biased member configured to engage the recesses at discrete angular positions, such as 90°, 95°, 100°, 105°, 110°, 115°, and 120°. In some embodiments, the central joint can include friction pads or clamps configured to resist rotation once the desired angle is achieved.

At 2840, forming a selected angle between the first member and the second member of the articulating leg can include positioning the articulating leg in a deployed configuration by rotating the first member relative to the second member until a selected angle greater than ninety degrees is achieved. This operation can provide a stable geometry for supporting a user during entry or exit from a vehicle. In some embodiments, the selected angle can range from about 90 degrees to about 120 degrees, including all intermediate values. In some embodiments, the angle can be selected based on ergonomic considerations, such as positioning the first member substantially parallel to a ground surface while the second member is substantially perpendicular to the ground surface. In other embodiments, the angle can be adjusted to accommodate variations in striker height or ground conditions, allowing the device to maintain stability on uneven terrain.

In some embodiments, the angle can be locked using a ball-and-spring detent assembly disposed within the central joint. The ball-and-spring assembly can include a spring-biased ball configured to engage detent recesses corresponding to discrete angular positions, such as 90°, 95°, 100°, 105°, 110°, 115°, and 120°, thereby maintaining the articulating leg in a fixed position until a threshold torque is applied to overcome the spring force. In other embodiments, the angle can be locked using a friction clamp integrated into the central joint, wherein the clamp applies compressive force to resist rotation between the first and second members. In some embodiments, the angle can be secured using a pin lock mechanism, such as a dowel pin configured to engage an arcuate guide slot formed in one of the hinge members, the guide slot including locking apertures corresponding to selected angular positions.

Hydraulic or pneumatic locking systems can be configured to provide smooth and controlled adjustment of the angle, or ratchet-based locking mechanisms that allow incremental adjustment can be used. In some embodiments, electronic or motorized locking systems can be employed to enable automated deployment and locking of the articulating leg at a user-selected angle.

At 2850, placing a first base coupled to a distal end of the right second member and a second base coupled to a distal end of the left second member on the ground surface can include positioning the distal ends of the right and left second members so that their respective bases contact the ground surface, thereby providing stability for the vehicle access device.

In some embodiments, each base can include a substantially flat bottom surface configured to maximize contact with the ground and resist slippage. In some embodiments, the bases can be formed from high-friction materials such as rubber or textured polymer to enhance traction. In other embodiments, the bases can include anti-slip pads integrated into the bottom surface to prevent movement on smooth or wet surfaces. In some embodiments, the bases can include suction cups configured to create a vacuum seal with the ground surface for additional grip. In other embodiments, the bases can include magnetic feet configured to engage ferromagnetic surfaces, such as steel flooring, to provide secure anchoring.

In some embodiments, the bases can include pivot joints operably coupled to the second members, allowing the bases to rotate about one or more axes to maintain flat contact with uneven terrain. In other embodiments, the bases can include ball-and-socket joints or multi-axis hinges to accommodate angular variations in the ground surface. In some embodiments, the bases can include integrated shock absorbers or vibration dampers to improve stability when the device is used on irregular or rough surfaces.

At 2860, locking the first member in a fixed position can include securing the first member and second member at the selected angle to maintain the articulating leg in a deployed configuration.

In some embodiments, locking can include actuating a locking mechanism integrated into the central joint to prevent relative rotation between the first and second members. In some embodiments, the locking mechanism can include a ratchet assembly configured to engage teeth along an arcuate path, allowing incremental adjustment and secure locking. In other embodiments, the locking mechanism can include a friction clamp configured to apply compressive force between hinge components to resist movement. In some embodiments, the locking mechanism can include a spring-biased detent assembly configured to engage recesses corresponding to discrete angular positions, such as 90°, 105°, or 120°.

In some embodiments, the locking mechanism can include a pin lock system, wherein a dowel pin is inserted through aligned apertures in hinge members to maintain the selected angle. In other embodiments, hydraulic or pneumatic locking systems can be employed to provide smooth and controlled locking and unlocking. In some embodiments, electronic or motorized locking systems can be integrated to enable automated securing of the articulating leg at a user-selected angle. Additional embodiments can include redundant locking features, such as secondary clamps or safety latches, to prevent accidental unlocking during use.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize or be able to ascertain using no more than routine experimentation, many equivalents to the specific inventive embodiments described herein. It is, therefore, to be understood that the foregoing embodiments are presented by way of example only and that, within the scope of the appended claims and equivalents thereto; inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

Also, various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.” The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

The terms “substantially,” “approximately,” and “about” used throughout this Specification and the claims generally mean plus or minus 10% of the value stated, e.g., about 100 would include 90 to 110.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed is:

1. A device, comprising:
an engagement portion including a rigid member, the rigid member configured to engage a striker in a doorframe of a vehicle and to hold the device in a fixed relationship relative to the striker; and
an articulating leg coupled to the rigid member, the articulating leg including a first member and a second member, and a central joint configured to pivotably couple the first member and the second member, the second member comprising;
a right second member and a left second member; and
an extension mechanism operably coupled to the central joint and to the right and left second members, the extension mechanism configured to adjust the length of the second member relative to a ground surface.

2. The device of claim 1, wherein the extension mechanism comprises:
an elongated portion having a plurality of apertures disposed longitudinally along its length; and
a connector body comprising a first portion and a second portion, the first and second portions being coupled together to define an inner cavity, the inner cavity configured to receive the elongated portion, the right second member, and the left second member, the elongated portion is disposed between the right and the left second members.

3. The device of claim 2, wherein the connector body comprises a first end and a second end, wherein the first end includes a first protruding shoulder configured to engage with the right second member, and the second end includes a second protruding shoulder configured to engage with the left second member.

4. The device of claim 2, further comprising:
a release pin mechanism disposed within the inner cavity and operably coupled to the elongated portion; and
a button accessible through an external surface of the connector body, the button configured to actuate the release pin mechanism, wherein the button and release pin mechanism are operable to selectively lock or release the elongated portion.

5. The device of claim 2, further comprising a locking mechanism configured to engage with the apertures to secure the elongated portion at a selected position.

6. The device of claim 2, wherein the elongated portion is a tubular member having a non-circular cross-section.

7. The device of claim 1, wherein the central joint comprises:
a hinge mechanism including a biasing assembly disposed within an internal cavity formed between a pair of coupled hinge members, the biasing assembly comprising a movable member and an elastic element configured to urge the movable member toward one or more detent recesses corresponding to discrete angular positions, thereby maintaining the articulating leg in each position until a threshold torque is applied to transition between positions.

8. The device of claim 7, wherein the biasing assembly comprises:
a ball-and-spring assembly, the ball-and-spring assembly comprising a ball and a spring, and being configured to apply a spring force that urges the ball into detent recesses corresponding to an open position and a closed position, the spring maintaining the articulating leg in either position until a threshold force is applied to transition between the positions.

9. The device of claim 8, wherein the internal cavity comprises:
an arcuate track along which the ball travels, the track including detent recesses corresponding to an angular range between the first and second members of about 0 degrees in a closed position and about 120 degrees in an open position, movement of the ball along the arcuate track dictating the transition between positions when sufficient force is applied to overcome the spring bias.

10. The device of claim 7, wherein the pair of coupled hinge members comprises:
a first hinge member and a second hinge member, the first hinge member including a dowel pin and the second hinge member defining a guide slot that receives the dowel pin, the guide slot defining an arcuate path having detent recesses corresponding to an angular range between the first and second members of about 0 degrees in a closed position and about 120 degrees in an open position, the dowel pin being configured to snap into the detent recesses to maintain the articulating leg in an open or closed position until sufficient force is applied to transition between the positions.

11. The device of claim 1, further comprising:
a grip material disposed on at least a portion of a surface of the second member.

12. The device of claim 1, wherein a proximal portion of the rigid member includes a flared segment protruding outward from the rigid member, the flared segment having an indented region configured to interface with a D-ring striker plate.

13. The device of claim 1, wherein a distal end of the right second member coupled to a first base, and a distal end of the left second member coupled to a second base.

14. A method, comprising:
engaging an engagement portion of a vehicle access device to a striker located in a doorframe of a vehicle;
unfolding an articulating leg coupled to the engagement portion, the articulating leg comprising a first member and a second member pivotably connected to each other, the second member comprising a right second member and a left second member, each configured to be placed onto a ground surface;
forming a selected angle between the first member and the second member of the articulating leg such that the selected angle is larger than ninety degrees; and
placing a first base coupled to a distal end of the right second member and a second base coupled to a distal end of the left second member on the ground surface to support the vehicle access device.

15. The method of claim 14, wherein engaging the engagement portion comprises:
inserting a proximal flared segment of a rigid member of the engagement portion beneath the striker such that an indented region of the flared segment receives and supports a lower portion of the striker, the flared segment protruding outward from the rigid member and being configured to interface with a D-ring striker plate.

16. The method of claim 14, further comprising:
locking the first member in a fixed position relative to the second member.

17. The method of claim 14, further comprising:
adjusting length of the second member relative to the ground surface by actuating an extension mechanism operably coupled to the right and left second members.

18. The method of claim 17, wherein adjusting the length comprises sliding an elongated portion having a plurality of apertures longitudinally along its length within a connector body that defines an inner cavity receiving the elongated portion and the right and left second members.

19. The method of claim 18, further comprising:
locking the elongated portion at a selected position by engaging a locking mechanism with one of the apertures.

20. The method of claim 18, further comprising actuating a release pin mechanism disposed within the inner cavity by pressing a button accessible through an external surface of the connector body, the release pin mechanism being operable to selectively lock or release the elongated portion.

21. A kit, comprising:
an engagement portion including a rigid member, the rigid member configured to engage a striker in a doorframe of a vehicle and to hold a vehicle access device in a fixed relationship relative to the striker;
an articulating leg coupled to the rigid member, the articulating leg including a first member and a second member pivotably coupled to each other, the second member comprising a right second member and a left second member, each configured to be placed onto a ground surface; and
a first base configured to couple to a distal end of the right second member and a second base configured to couple to a distal end of the left second member on the ground surface to support the vehicle access device.

22. The kit of claim 21, further includes:
an elongated portion configured to be received within a connector body, the connector body defining an inner cavity configured to receive the elongated portion and the right and left second members, the connector body operable to slidably connect the elongated portion to the right and left second members so as to adjust a length of the second member.
